(19) United States
(12) Patent Application Publication
(10) Pub. No.: US 2013/0316126 A1
(43) Pub. Date: Nov. 28, 2013

(54) CORE LAYER HAVING STICK-LIKE ELEMENTS AND MULTI-LAYERED COMPOSITE CONTAINING THE CORE LAYER

(71) Applicants: Achim Moeller, Dresden (DE); Thomas Eckstein, Dresden (DE)

(72) Inventors: Achim Moeller, Dresden (DE); Thomas Eckstein, Dresden (DE)

(73) Assignee: PADANA AG, Baar (CH)

(21) Appl. No.: 13/886,447

(22) Filed: May 3, 2013

Related U.S. Application Data
(60) Provisional application No. 61/642,529, filed on May 4, 2012.

(30) Foreign Application Priority Data
May 4, 2012 (EP) 12003428.5

(51) Int. Cl. E04C 2/36; B32B 38/00

(52) U.S. Cl. CPC E04C 2/36; B32B 38/0004; B32B 38/0012
USPC 428/106; 428/107; 428/109; 156/60; 156/254; 156/221

(57) ABSTRACT

A core layer, a multi-layered composite, and methods of producing the same are provided. The core layer includes a first layer having first stick-like elements and a second layer having second stick-like elements. In each layer the stick-like elements are spaced apart and separated from each other by a cavity. A first stick-like element in the first layer and a second stick-like element in the second layer include an angle with each other which is different from zero, and the first layer and the second layer are fixedly interconnected.

### CROSS-REFERENCE TO RELATED APPLICATIONS

This application claims priority to and any other benefit of U.S. Provisional Patent Application Ser. No. 61/642,529, filed on May 4, 2012, and also claims priority to and any other benefit of European Patent Application Number 12003428.5, filed on May 4, 2012, the entire contents of which are incorporated by reference herein.

### TECHNICAL FIELD

The present invention relates to a core layer, having stick-like elements, which is suitable for producing a multi-layered composite, preferably for producing a lightweight building board, and also relates to a multi-layered composite which has the core layer. The invention furthermore relates to a method for producing the core layer and the multi-layered composite.

### BACKGROUND

It is known to use composite materials for producing multi-layered composites which have relatively high mechanical stability in comparison to their weight. Such multi-layered composites are used in the form of lightweight building boards, for example.

CN 2012000133 relates to a multi-layered composite in which a lattice-like core layer is arranged between two cover layers.

CN 101856888 relates to a multi-layered composite in which a core layer is arranged between two cover panels, which core layer consists of two lattice-like layers which are symmetrical in relation to each other and are connected in each case to a cover layer.

U.S. Pat. No. 5,829,215 relates to a multi-layered composite in which stick-like elements are arranged in two layers between two cover panels so that the core layer obtains a lattice-like construction. Cavities between the stick-like elements are foam-filled by means of a hardened resin.

WO 94/08766 relates to a derived timber product consisting of thin plate-like elements which overlap each other in a predominantly shingle-like manner, are arranged essentially parallel to the surface of the plate-like or moulded part-like derived timber product and are fixedly interconnected by means of adhesive.

DE 196 10 247 relates to the use of plant stalks and plant fibres for compression moulded parts, for example for wall panel materials.

DE 1 924 619 relates to a wood core plywood board which consists of a middle layer constructed from small wooden sticks and a cover veneer, or a plurality of cover veneers.

Common to these multi-layered composites is the fact that the core layer has an open structure. A disadvantage of open core layers lies in the fact that they can have a low homogeneity which is brought about as a result of relatively large cavities in the core layer. Then, when introducing fastening means, such as nails or screws or furniture connections, these can encounter cavities in the open core layers. This can result in restricted stability of the fastening means in the multi-layered composite. This in turn can lead to the possibility of impairment of the stability of the multi-layered composite on a support, for example on a wall, if this multi-layered composite is to be fastened on the wall with the aid of nails or screws.

### SUMMARY

One object of the present invention is to provide a core layer and a multi-layered composite containing the core layer, which has improved stability with regard to the fastening with nails or screws or equivalent fastening means on a support, for example on a wall.

This object is achieved according to the invention with a core layer and a multi-layered composite having the core layer according to the subsequently disclosed three aspects of the invention.

According to a first aspect of the invention, this object is achieved with a core layer which is suitable for a multi-layered composite which has at least one cover layer and the core layer, wherein the cover layer is arranged so that it at least partially covers the core layer and is fixedly connected to this, and a multi-layered composite having the core layer, wherein the core layer has layers of stick-like elements which are arranged in a lattice-like manner.

According to a second aspect, the object is achieved according to the invention with a core layer which is suitable for a multi-layered composite which has at least one cover layer and the core layer, wherein the cover layer is arranged so that it at least partially covers the core layer and is fixedly connected to this, and with the multi-layered composite having the core layer, wherein the core layer has at least one wooden element which has at least one recess.

According to a third aspect, the object according to the invention is achieved with a core layer which is suitable for a multi-layered composite which has at least one cover layer and the core layer, wherein the cover layer is arranged so that it at least partially covers the core layer and is fixedly connected to this, and with the multi-layered composite having the core layer, wherein the core layer has wooden elements which are arranged irregularly in the core layer.

According to a fourth aspect, the invention furthermore relates to the use of the multi-layered composite/multi-layered composites according to the invention and also to the use of the core layer according to the invention or the core layers according to the invention.

### BRIEF DESCRIPTION OF THE DRAWINGS

FIG. 1 shows a plan view of a core layer according to the invention.

FIG. 2 shows a cross section of the core layer of FIG. 1 along the line A.

FIG. 3 shows a cross section of a preferred embodiment of a multi-layered composite according to the invention.

FIG. 4 shows a cross section of a further preferred embodiment of a multi-layered composite according to the invention.

FIG. 5 shows a cross section of a further preferred embodiment of a multi-layered composite according to the invention.

FIG. 6 shows a plan view of a core layer according to the invention of a further preferred embodiment of a multi-layered composite according to the invention.

FIG. 7 shows a plan view of a core layer according to the invention of a further preferred embodiment of a multi-layered composite according to the invention.

FIG. 8 shows a plan view of the core layer of a further preferred embodiment of a multi-layered composite according to the invention.

FIG. 9a shows a cross section of the pressure deformed (compressed) edge of a core layer according to the invention or of a multi-layered composite according to the invention.

FIG. 9b shows a section of the pressure deformed (compressed) edge of the core layer according to the invention of the multi-layered composite according to the invention of FIG. 9a.

FIG. 10a shows two stick-like elements, as used according to the invention, which are cut in a curve-like or waveform or corrugated manner.

FIG. 10b shows stick-like elements of FIG. 10a which are displaced from each other in the longitudinal direction so that they are spaced apart and form cavities between them.

FIG. 11 shows a device for implementing a method for producing stick-like wooden elements.

FIG. 12 shows a method for the oblique orientation of stick-like wooden elements.

FIG. 13 shows a method for spreading out stick-like wooden elements.

FIG. 14 shows a lattice of stick-like wooden elements.

FIG. 15 shows a multi-layered composite according to the invention according to the second embodiment from the side, in which first and second stick-like wooden elements are not orientated parallel to the cover layer.

FIG. 16 shows a photo of a core layer which is used in a multi-layered composite according to FIG. 15.

FIG. 17a shows a stress pattern of the core layer according to the invention according to the second embodiment.

FIG. 17b shows a further stress pattern of the core layer according to the invention according to the second embodiment.

FIG. 17c shows a further stress pattern of the core layer according to the invention according to the second embodiment.

FIG. 18a shows a lattice of stick-like elements which is used for producing the core layer according to the invention according to the second embodiment.

FIG. 18b shows the lattice of stick-like elements of FIG. 18a in plan view.

FIG. 19 shows a block having of a plurality of lattices of FIGS. 18a and 18b.

FIG. 20 shows a core layer which is cut out from the block of FIG. 19.

FIG. 21 shows an image of a core layer which is cut out from the block of FIG. 19.

FIG. 22 shows a wood surface with predetermined breaking points.

FIG. 23 shows a further embodiment of a wooden element according to the invention.

FIG. 24a shows a further embodiment of a wooden element according to the invention.

FIG. 24b shows a further embodiment of a wooden element according to the invention.

FIG. 24c shows the opened out wooden element of FIG. 24b.

FIG. 25a shows a stack of veneers which form a block.

FIG. 25b shows wooden elements according to the invention which can be produced from the stack of FIG. 25a.

FIG. 26 shows one embodiment of wooden elements according to the invention.

FIG. 27 shows a detail of a core layer in which the stick-like wooden elements of FIG. 26 are arranged in an irregularly distributed manner.

FIG. 28 shows a multi-layered composite, preferably in the form of a lightweight building board, having a cover layer and a core layer, which has wooden elements according to the invention.

FIG. 29 shows a further embodiment of wooden elements according to the invention.

### DETAILED DESCRIPTION

First Aspect of the Invention

Core layers according to the invention having stick-like elements, which form lattice-like structures, and multilayered composites according to the invention containing the core layers.

According to a first aspect of the invention, an object of the invention is achieved with a core layer which is suitable for a multi-layered composite which has at least one cover layer and the core layer, wherein the cover layer is arranged so that it at least partially covers the core layer and is fixedly connected to this, and a multi-layered composite having the core layer, wherein the core layer has layers of stick-like elements which are arranged in a lattice-like manner.

First Exemplary Embodiment of a Core Layer

According to a first exemplary embodiment, the invention relates to a core layer which is suitable for a multi-layered composite which has at least one cover layer and a core layer, wherein the cover layer is arranged so that it at least partially covers the core layer and is fixedly connected to this, at least having: (a) a first layer (I) having first stick-like elements; (b) a second layer (II) having second stick-like elements; wherein in each layer (I) and (II), stick-like elements are spaced apart in each case and are separated from each other by a cavity in each case; a first stick-like element in the layer (I) and a second stick-like element in the layer (II) include an angle with each other which is different from zero; and the first layer (I) and the second layer (II) are fixedly interconnected.

The term “core layer which is suitable for a multi-layered composite”, as used in this disclosure, means a core layer which is suitable for producing a multi-layered composite, or which can be present in a multi-layered composite.

The term “core layer”, as used herein, means a layer having stick-like elements, preferably stick-like elements comprising wood, which has an open structure, that is to say has cavities. According to the invention, the core layer has at least one layer (I) having first stick-like elements and a second layer (II) having second stick-like elements, wherein in each layer (I) and (II) stick-like elements are spaced apart in each case and are separated from each other in each case by a cavity. In this way, the open structure of the core layer is formed.

The term “cover layer” means a layer of material which serves preferably as a carrier for the core layer. According to the invention, the cover layer is arranged so that it at least partially covers the core layer and is fixedly connected to this. The core layer can also be at least partially covered by at least two cover layers and be fixedly connected to these. The core layer is then preferably located between the two cover layers. The cover layer can consist of wood or comprise wood. Other materials, such as metal sheets or plastics, are equally applicable.

The term “at least partially covers” implies that the cover layer can even completely overlap or cover the core layer.

The term “multi-layered composite”, as used herein, means a composite comprising at least one core layer and at least one cover layer.

So that the core layer has the necessary stability, according to the invention it is provided that a first stick-like element in the layer (I) and a second stick-like element in the layer (II) include an angle with each other which is different from zero.

The term “angle which is different from zero” implies that the angle is neither 180° nor 360°.

The term “stick-like element” means an element with a straight shape or an element which features a straight shape. A stick-like element is preferably formed so that it follows a straight line. This straight line can form a symmetry axis for the stick.

The term “element” means a component of the core layer or of the multi-layered composite.

Stick-like elements can be solid or can have recesses. The surface of a stick-like element can be smooth or can be rough.

The term “recess”, as used herein, means an opening in the stick-like wooden element. Recesses can preferably be in the form of holes or grooves or notches. A recess can be created preferably by means of milling, drilling, treatment with a laser and/or notching of the surface of the wooden element. Stick-like elements with recesses have a lower weight than the corresponding solid stick-like elements. The use of stick-like elements which have recesses assists the production of a core layer according to the invention or of a multi-layered composite according to the invention with reduced weight or lower density.

Stick-like elements can preferably comprise wood or consist of wood. The production of such stick-like elements is known from the field of woodworking. Stick-like elements consisting of wood can be produced according to known processes, as disclosed in DD 271670, for example, which is hereby incorporated by reference in its entirety. Described therein is the production of stick-like wooden elements by the cutting of veneers.

The dimensions of the stick-like elements can be freely selected in the main. For example, the lengths of the stick-like elements can lie within the range of between 0.1 m and 10 m, preferably between 0.2 m and 5 m, or can be selected corresponding to the dimensions of the lightweight building board which is to receive the core layer.

The height or the width of the stick-like elements lies within the range of between 0.2 mm and 50 mm, preferably between 1 mm and 20 mm.

Apart from stick-like elements which are produced from wood or feature wood, use may also be made of stick-like elements which consist of metal or comprise metal, for example a light metal such as aluminum, or which consist of plastic or comprise plastic.

In a preferred embodiment, the stick-like elements consist of wood or comprise wood.

In one embodiment, the stick-like elements have a square or a rectangular cross section.

The stick-like element can also be asymmetrical, at least partially asymmetrical or for the most part completely asymmetrical. Furthermore, it is also possible that a stick-like element extends in the shape of a curve or has a waveform or cambered shape, at least partially or for the most part over its entire length, for example in the shape of a sinusoidal curve. Such a curved or waveform or cambered stick-like element can be produced by means of corresponding cutting out from a wooden board. Alternatively, a non-cutting forming of an originally straight stick-like element according to known forming processes is possible. According to a specific variant, the forming with the curvature radius of zero, i.e. a sharp-edged bending of the stick-like element, is also possible, as is known in the case of chip baskets, for example. Subsequent to this, the individual stick-like elements can be arranged in the longitudinal direction in such a way that the stick-like elements are spaced apart and form a cavity between them.

The first layer (I) and the second layer (II) of the core layer, which have the first stick-like elements and the second stick-like elements, are fixedly interconnected. This means that the layers (I) and (II) are fixedly interconnected, that is to say first stick-like elements are preferably glued to second stick-like elements or are interconnected by other fastening means. The fixed connection is preferably carried out by means of an adhesive, that is to say by gluing.

The first stick-like elements and the second stick-like elements can be aligned in any orientation with each other in the corresponding layers, that is to say in the first layer (I) and in the second layer (II), assuming stick-like first elements of the first layer (I) include an angle with stick-like second elements of the second layer (II) which is different from zero. Since the first stick-like elements and the second stick-like elements are localized in layers which are different from each other, that is to say in the first layer (I) or in the second layer (II), the stick-like elements together, in their respective layers, inevitably have to form a lattice in plan view. This lattice comprises first and second stick-like elements which intersect. The pattern of the lattice is preferably rhombic, rectangular or square.

In one embodiment, the first stick-like elements of the first layer (I) are arranged parallel to each other. In one embodiment, the first stick-like elements in the layer (II) are separated from each other by the same distance.

The second stick-like elements in the second layer (II) are preferably also orientated parallel to each other. The second stick-like elements are preferably also separated from each other by the same distance.

It is also possible that all the first stick-like elements and all the second stick-like elements in their respective layers (I) and (II) are orientated parallel to each other in each case.

In one embodiment, in which the first stick-like elements and the second stick-like elements are orientated parallel to each other in each case, a lattice with a regular pattern is formed.

The term “regular pattern” defines a periodically repeating pattern. Such a pattern which periodically repeats itself can be a rhombic, a rectangular, or a square pattern, for example.

In one preferred embodiment, the first stick-like elements and the second stick-like elements are orientated perpendicularly to each other in each case. Accordingly, the lattice has a rectangular or a square pattern.

Accordingly, in one embodiment the arranging of at least all the first and second stick-like elements in the layer (I) and the layer (II) parallel to each other is excluded. In a parallel arrangement, specifically first and second stick-like elements form an angle between them which is equal to zero.

In the case of stick-like elements which are straight, first and second stick-like elements are particularly arranged so that they extend obliquely or in an inclined manner to each other.

In a particular embodiment, the core layer is characterized in that first stick-like elements in the layer (I) are orientated parallel to each other, and second stick-like elements in the layer (II) are orientated parallel to each other, wherein a first stick-like element in the layer (I) and a second stick-like element in the layer (II) include an angle with each other which is different from zero; and wherein the first layer (I) and the second layer (II) are fixedly interconnected.

First stick-like elements in the layer (I) preferably form an angle of 90° with second stick-like elements in the layer (II).

The angle is measured for example at a point of the smallest distance between a first stick-like element and a second stick-like element.

In one embodiment, the core layer is also characterized in that the first layer (I) and the second layer (II) form a plane surface between them.

In one preferred embodiment of the core layer, the core layer has a third layer (III) which has third stick-like elements, wherein third stick-like elements are arranged in the core layer so that they overlap with cavities which are formed by stick-like first elements of the first layer (I) or by stick-like second elements of the second layer (II), wherein the third layer (III) is fixedly connected to the first layer (I) or to the second layer (II).

The third stick-like elements are also preferably spaced apart and separated from each other by a cavity.

The third stick-like elements can be arranged inside the third layer in an arbitrary direction. It is preferred, however, that the third stick-like elements are orientated parallel to each other.

Third stick-like elements can include an angle with the first or second stick-like elements which is different from zero.

In one embodiment, third stick-like elements are orientated parallel to the first stick-like elements or are orientated so that they intersect the first stick-like elements at an angle of 90°.

In one embodiment, third stick-like elements are orientated parallel to the second stick-like elements or are orientated so that they intersect the second stick-like elements at an angle of 90°.

In one embodiment, first and third stick-like elements are arranged parallel to each other in their respective different layers (I) and (III), wherein third stick-like elements are arranged so that they overlap with cavities which are formed by first stick-like elements, or so that they at least partially overlap with these. The cavities between the first stick-like elements are preferably covered by the third stick-like elements.

In one embodiment, preferably in which second and third stick-like elements are arranged parallel to each other in their respective different layers (II) and (III), third stick-like elements are arranged so that they overlap with cavities which are formed by second stick-like elements, or at least partially overlap with these. The cavities between the second stick-like elements are preferably covered by the third stick-like elements.

In one embodiment, the first, the second and the third stick-like elements are arranged in their respective layers (I) to (III) so that the formed core layer in plan view has no openings which could be formed by first and second stick-like elements in combination with third stick-like elements.

An arrangement in which third stick-like elements are arranged so that they cover cavities or at least partially overlap these, which are formed by second stick-like elements, or wherein third stick-like elements are arranged so that they overlap cavities or at least partially cover these, which are formed by first stick-like elements, and wherein the core layer in plan view has no openings which are formed by first and second stick-like elements in combination with third stick-like elements, has the advantage that when introducing nails or screws perpendicularly to the core layer these always meet with resistance. In this way, such an arrangement has increased stability when fastening with screws or nails, for example, on a support, for example on a wall. If such an arrangement is fastened with a nail, for example, the nail must at least out of necessity penetrate a layer of the core layer, for example the third layer (III), or the second layer (II) or the first layer (I). If the third stick-like elements were not to cover the cavities or were not to at least partially overlap the cavities which are formed in the first layer (I) or in the second layer (II) by respective first or second stick-like elements, a nail or a screw could encounter a cavity when being fastened. This is especially of importance when the core layer is overlaid by a cover layer so that from the outside it cannot be detected whether the nail has only encountered a cavity in the core layer or encountered a stick-like element, that is to say a first, second or third element. The present invention therefore overcomes this disadvantage.

An arrangement in which third stick-like elements are arranged parallel to first (or second) stick-like elements and do not cover the cavities formed by the first (or second) stick-like elements is not preferred or even excluded.

In one embodiment, the fixed connection of the first layer (I) to the second layer (II) can be effected by means of adhesive bonding. Similarly, the fastening of the third layer (III) to the first or second layer can also be carried out by adhesive bonding.

In a further embodiment, it is possible to effect the fixed connection by a fourth layer (IV) being introduced between the first layer (I) and the second layer (II), and by the first layer (I) and the second layer (II) being connected to the fourth layer (IV) in each case. The connecting can again be carried out by adhesive bonding. The fourth layer (IV) can be selected from veneer, wooden board, chipboard, fibreboard, plywood board, plastic sheet, plasterboard, sheet metal plate, and fibre cement board.

Consequently, the fixed connection can be effected by means selected from the group: adhesive; and/or by a fourth layer (IV) of a material selected from: veneer, wooden board, chipboard, fibreboard, plywood board, plastic sheet, plasterboard, sheet metal plate, and fibre cement board, and wherein said fourth layer (IV) is arranged between the first layer (I) and the second layer (II) or between the first layer (I) and the third layer (III) or between the second layer (II) and the third layer (III).

The core layer according to the invention can be produced according to a method which has at least the steps (i) to (iii):
(i) arranging of first stick-like elements in such a way that elements are spaced apart and separated from each other by a cavity in each case, wherein they form a first layer (I);
(ii) arranging of second stick-like elements in such a way that elements are spaced apart and separated from each other by a cavity in each case, wherein they form a second layer (II);
(iii) fixed connecting of the first layer (I) to the second layer (II) in such a way that a first stick-like element in the layer (I) and a second stick-like element in the layer (II) include an angle with each other which is different from zero.

The arranging according to steps (i) and (ii) preferably comprises the adhesive connecting or adhesive bonding of the first or of the second stick-like element to a carrier material so that the individual stick-like elements are arranged at a defined distance from each other, and wherein the cavities are formed between corresponding stick-like elements.

In one embodiment, the carrier material is selected from the group consisting of thread, thread in the form of a lattice or grid, non-woven fabric, foil, woven fabric, fusible plastic or hot-melt adhesive.

Such a procedure has the advantage that the carrier material can be provided in an “endless form”. The term “endless form” means that the carrier material can be provided in a continuous manner over a roller or another device, for example.

In one embodiment, the stick-like elements are mechanically interconnected by means of stitching or interweaving with a thread. Following the stitching or interweaving, the created layers can be temporarily supported and can be further processed separately from each other, for example by gluing or formatting.

In one embodiment, first stick-like elements, arranged as in step (i), can be provided with an adhesive at the points with which they make contact with second stick-like elements, arranged as in step (ii), and can be fixedly interconnected, for example by means of adhesive bonding, according to step (iii). It is possible to provide all possible contact points, or only some of them, with an adhesive.

The adhesive bonding can be assisted by applying pressure and/or temperature, as is known in the prior art. The pressure preferably lies within a range of between 0.001 MPa and 1.5 MPa, more preferably within a range of between 0.01 MPa and 1.0 MPa. The temperature can lie within a relatively wide range, preferably within a range of between 10° C. and 150° C., more preferably between 20° C. and 100° C.

If the core layer is to be provided with a cover layer, then the cover layer can be connected to the core layer—produced according to steps (i) to (iii)—by fastening, preferably by bonding by means of an adhesive.

If desirable, a third layer (III), which has third stick-like elements, can be applied to the second layer. The third stick-like elements can be fastened to the second stick-like elements similar to the way in which the second stick-like elements are fastened to the first stick-like elements.

The arranging according to step (i) and/or step (ii) can furthermore have at least the steps (i′) and/or (ii′) or (i″) and/or (ii″), i.e. the step (i) can have the steps (i′) and/or (i″), and the step (ii) can have the steps (ii′) and/or (ii″):
(i′) and/or (ii′): adhesive connecting of first and/or second stick-like elements to a carrier material, wherein the carrier material is selected from the group consisting of: thread; thread in the form of a lattice or a grid; non-woven fabric; foil; woven fabric; fusible plastic; hot-melt adhesive; wherein the carrier material for the adhesive connection is provided discontinuously or continuously;
(i″) and/or (ii″): mechanical connecting of first and/or second stick-like elements by means of stitching or interweaving with a thread, wherein if necessary after the stitching or interweaving the produced first layer (I) and/or second layer (II) can be further processed separately from each other.

It is naturally possible that the core layer can have a plurality of layers (I) and (II), preferably at least two first layers (I) and two second layers (II), wherein the layers (I) and (II) are arranged in an alternating manner.

It is also possible that the core layer has more than one third layer (III) and/or more than one fourth layer (IV).

In one embodiment, the core layer can have more than 10 first layers (I) and more than 10 second layers (II), preferably more than 20 first layers (I) and more than 20 second layers (II), more preferably more than 30 first layers (I) and more than 30 second layers (II) or more than 40 first layers (I) and more than 40 second layers (II), more preferably more than 50 first layers (I) and more than 50 second layers (II).

In a particular embodiment, the core layer has at least one first layer (I) and at least one second layer (II), and at most 1,000 first layers (I) and at most 1,000 second layers (II).

In a further embodiment, the core layer has at least 10 first layers (I) and at least 10 second layers (II), and at most 200 first layers (I) and at most 200 second layers (II).

In a further embodiment, a cover layer can be used as carrier material. Accordingly, the arranging of the steps (i) or (ii) on a cover layer can be carried out, wherein the stick-like elements which are to be spaced apart obtain their fixing to each other by adhesive bonding to the cover layer.

In one embodiment, the method then has the following step (i):
(i) arranging of first stick-like elements in such a way that elements are spaced apart and separated from each other by a cavity in each case, wherein they form a first layer (I); and wherein the arranging on a cover layer is carried out, wherein first stick-like elements are adhesively bonded to the cover layer.

In this embodiment, the method according to step (i) has the steps (ii) and (iii) in one embodiment:
(ii) arranging of second stick-like elements in such a way that elements are spaced apart and separated from each other by a cavity in each case, wherein they form a second layer (II); wherein the arranging on the stick-like first elements, which were arranged according to step (i), is carried out;
(iii) fixed connecting of the first layer (I) to the second layer (II) in such a way that a first stick-like element in the layer (I) and a second stick-like element in the layer (II) include an angle with each other which is different from zero.

Second Exemplary Embodiment of a Core Layer

According to a second exemplary embodiment, the invention relates to a core layer which is suitable for a multi-layered composite which has at least one cover layer and a core layer, wherein the cover layer is arranged so that it at least partially covers the core layer and is fixedly connected to this, characterized in that this core layer is produced from the core layer according to the first embodiment.

The production of this core layer from the core layer of the first embodiment is carried out according to a method which has the step (i):
(i) cutting of the core layer of the first embodiment in two mutually parallel cutting planes, wherein the cutting planes extend obliquely to the plane surface which in the core layer of the first embodiment is formed between the first layer (I) and the second layer (II).

The term “obliquely”, as used herein, means that a cutting plane and said plane surface include an angle with each other which is different from 0°.

According to a second exemplary embodiment, the invention relates to a core layer which is suitable for a multi-layered composite which has at least one cover layer and a core layer, wherein the cover layer is arranged so that it at least partially covers the core layer and is fixedly connected to this, characterized in that it can be produced from the core layer according to the first embodiment, or according to one of the embodiments referred to therein, wherein the production comprises at least the step (i):
(i) cutting of the core layer of the first embodiment in two mutually parallel cutting planes, wherein the cutting planes extend obliquely to the plane surface which in the core layer of the first embodiment is formed between the first layer (I) and the second layer (II).

In one embodiment, the core layer is produced from the core layer of the first embodiment, wherein the core layer of the first embodiment has at least 20 first layers (I) and at least 20 second layers (II), and preferably at most 500 first layers (I) and at most 500 second layers (II).

By predetermining the cut according to step (i), it is possible to predetermine the ensuing cavities according to the necessary demands upon the properties of the core layer.

The direction of cut in the core layer of the first embodiment is preferably predetermined so that the stick-like elements form an angle with the plane surface which is determined by the layers (I) and (II), which angle lies within the range of between 30 and 60°, preferably about 45°.

In this case, the exactly identical cavities in the core layer are located as if the individual open planes were arranged parallel to the surface. This means that the core layer element has a mass which is less than the mass of solid material of a similar type.

As a result of the specific arranging of the individual open planes in relation to each other, i.e. intersecting of these planes, so that rectangular, square or rhombic cavities are created in the lattice structure, and also of a subsequent block formation by means of repeating first and second layers (I) and (II) and also by the predetermining of the cut, it is possible to arrange the ensuing cavities according to the required demands upon the properties of the core layer.

It is possible, for example, in such an embodiment to arrange the cavities—which for one thing are necessary in order to establish a favourable ratio of size to weight but for another thing bring about a decline in properties such as in screw extraction resistance—in the geometry of the core layer so that the orientation which is assumed to be the most disadvantageous is located in an infrequent stress pattern of the core layer. The term “stress pattern”, as used herein, symbolizes the frequency of the geometry of the cavities which is formed in the core layer.

In this embodiment, the core layer can be designed so that a connecting means, such as a nail or a screw, can no longer penetrate the core element without encountering adequate material. In particular, with the aid of such a core layer according to the invention according to the second embodiment, multi-layered composites can therefore be produced, having improved stability with regard to the fastening with nails or screws or equivalent fastening means on a support, for example on a wall.

Also shown to be advantageous is that as a result of the double oblique positioning an oblique first cutting of each stick element which exists on the surfaces (narrow surface and broad surface of the core layer according to the first embodiment) is effected. This brings about a surface enlargement without an increase of the mass being involved. This means that, with a larger spacing of the stick-like elements of the individual open planes—which corresponds to a reduction of the weight—in the core layer according to the second embodiment, the same surface density with stick-like elements can be guaranteed in comparison to the core layer of the first embodiment.

Third Exemplary Embodiment of a Core Layer

According to a third exemplary embodiment, the invention relates to a core layer which is suitable for a multi-layered composite which has at least one cover layer and a core layer, wherein the cover layer is arranged so that it at least partially covers the core layer and is fixedly connected to this, wherein the core layer is produced from the core layer according to the first exemplary embodiment or from the core layer according to the second exemplary embodiment. This core layer is preferably produced by means of pressure deformation of the core layers of the first or the second exemplary embodiments.

Accordingly, the invention relates to a core layer according to a third embodiment, which can be produced from the core layer according to the first embodiment; or can be produced from the core layer according to the second embodiment; wherein the production comprises at least the step (i):
(i) pressure deforming of the core layer according to the first embodiment or pressure deforming of the core layer according to the second embodiment in such a way that the first layer (I) and the second layer (II) do not form a plane surface between them.

In one embodiment, the edges of the core layers according to the first embodiment or the second embodiment of the core layer according to the invention can be pressure deformed, preferably by compression. In this way, it is possible to seal the cavities at the edges of the core layer. This pressure deforming can be carried out during the joining together of the core layers in a subsequent step, but also after the joining together of the core layers, by thermal softening of the adhesive on the edges, for example. This embodiment has the advantage that sealing of the edges, for example by applying a wooden strip, preferably a veneer strip, can be omitted.

During the compression process, the possibility arises of providing the edge section of the core layer with a crowned profile, that is to say a rounded profile. This is often desirable in the case of high-value furniture components, for example.

In a further embodiment, the core layer can be pressure deformed not only at the edges but additionally thereto, or even separately therefrom, at any points of the core layer.

The pressure deforming of wood, preferably of veneer, is known principally from DD 271670 and DE 101 24 912, which are hereby incorporated by reference in their entirety. The method which is disclosed there can be used for producing three-dimensionally deformed objects consisting of wood. According to the method which is disclosed there, a veneer sheet is split into wooden strips. The wooden strips are then displaced in the longitudinal direction, wherein the wood veneers can be formed in three dimensions and adhesively bonded to deformed objects. Objects deformed in this way have a compact cross section which has a high resistance to bending but a low resistance to twisting. Furthermore, the displacement of the wooden strips is made difficult as a result of the friction of the strip flanks, which leads to relatively large forming forces and ultimately to an increased risk of bending of the veneer strips and veneer sheets. Accordingly, the deformation of veneers in three-dimensionally deformed objects according to the method of this prior art is limited. The use according to the invention of stick-like elements for producing the core layers according to the invention according to the first and the second embodiment improves the properties of three-dimensionally deformed objects since the core layers according to the invention according to the first and the second embodiment do not only have a high resistance to bending but also a high resistance to twisting. In this way, the core layer according to the invention according to the third exemplary embodiment also has a high resistance to bending and a high resistance to twisting.

The invention also relates to multi-layered composites which have the core layers according to the invention.

The core layers according to the invention, i.e. the core layer according to the invention according to the first exemplary embodiment, the core layer according to the invention according to the second exemplary embodiment and the core layer according to the invention according to the third exemplary embodiment, can be used for producing a multi-layered composite. To this end, the core layer according to the invention, or the core layers according to the invention, can be attached to at least one additional layer—the cover layer—so that the cover layer at least partially covers the core layer and is fixedly connected to this.

Naturally, it is possible to attach the core layer between two cover layers.

It is furthermore possible to attach a core layer, or a multiplicity of core layers, according to the invention—wherein these can be the same or different—to a cover layer, or to a multiplicity of cover layers, preferably to one cover layer or between two cover layers, so that the one or two cover layers at least partially covers, or cover, the core layers and is, or are, fixedly connected to this, or to these.

Consequently, the invention relates furthermore to a multi-layered composite which has one core layer or a multiplicity of core layers according to the invention.

First Exemplary Embodiment of a Multi-Layered Composite

According to a first exemplary embodiment of a multi-layered composite, the invention relates to a multi-layered composite, at least having a cover layer and a core layer, wherein the cover layer is arranged so that it at least partially covers the core layer and is fixedly connected to this, wherein the core layer is the core layer according to the first exemplary embodiment.

In this embodiment, the invention also relates to a multi-layered composite, at least having a cover layer and a core layer, wherein the cover layer is arranged so that it at least partially covers the core layer and is fixedly connected to this, wherein the core layer is the core layer according to the first exemplary embodiment, and the cover layer is arranged parallel to the plane surface which is formed by the first layer (I) and the second layer (II) of the core layer.

For producing this multi-layered composite, first stick-like elements can be arranged on the cover layer of the multi-layered composite. Steps (i) to (iii) can then be carried out as described in the method for producing the core layer according to the first exemplary embodiment. In this case, it is possible to attach an additional cover layer on the core layer in such a way that the core layer is located between the two cover layers.

Accordingly, the invention also relates to a method for producing a multi-layered composite having at least the following steps (i) to (iii):
(i) arranging of first stick-like elements in such a way that elements are spaced apart and separated from each other by a cavity in each case, wherein they form a first layer (I);
(ii) arranging of second stick-like elements in such a way that elements are spaced apart and separated from each other by a cavity in each case, wherein they form a second layer (II);
(iii) fixed connecting of the first layer (I) to the second layer (II) in such a way that a first stick-like element in the layer (I) and a second stick-like element in the layer (II) include an angle with each other which is different from zero;
wherein the arranging on a cover layer is carried out in step (i), wherein the stick-like elements are fixedly connected to the cover layer, preferably by means of an adhesive; and/or wherein the core layer obtained according to step (iii) is arranged on a cover layer, wherein the core layer is fixedly connected to the cover layer, preferably by means of an adhesive.

Second Exemplary Embodiment of a Multi-Layered Composite

According to a second exemplary embodiment of a multi-layered composite, the invention relates to a multi-layered composite, at least having a cover layer and a core layer, wherein the cover layer is arranged so that it at least partially covers the core layer and is fixedly connected to this, wherein the core layer is the core layer according to the second exemplary embodiment.

In this embodiment, the invention also relates to a multi-layered composite, at least having a cover layer and a core layer, wherein the cover layer is arranged so that it at least partially covers the core layer and is fixedly connected to this, wherein the core layer is the core layer according to the second exemplary embodiment and the cover layer is not arranged parallel to the plane surface which is formed by the first layer (I) and the second layer (II).

Such a multi-layered composite is also characterized in that the individual stick-like elements in the layers (I) and (II) do not come to lie parallel to the at least one cover layer but form an angle with the cover layer which is different from zero.

Stick-like elements in the layers (I) and (II) preferably form an angle with the at least one cover layer which lies within the range of between 30 and 60°, preferably an angle of about 45°.

Such a multi-layered composite can preferably be produced by means of a method which provides the gluing of a core layer according to the second exemplary embodiment to a cover layer or to two cover layers.

Accordingly, the invention also relates to a method for producing a multi-layered composite according to the invention according to the second exemplary embodiment, having the step (i):
(i) fixed connecting of the core layer according to the second embodiment to a cover layer, preferably by means of an adhesive, in such a way that the cover layer at least partially covers the core layer, preferably completely covering the core layer.

Third Exemplary Embodiment of a Multi-Layered Composite

According to a third exemplary embodiment of a multi-layered composite, the invention relates to a multi-layered composite, at least having a cover layer and a core layer, wherein the cover layer is arranged so that it at least partially covers the core layer and is fixedly connected to this, wherein the core layer is the core layer according to the third exemplary embodiment.

This multi-layered composite can be produced from the multi-layered composite according to the first exemplary embodiment or from the multi-layered composite according to the second exemplary embodiment, wherein the production has at least the step (i):
(i) pressure deforming of the multi-layered composite according to the first embodiment or of the multi-layered composite according to the second embodiment in such a way that the first layer (I) and the second layer (II) do not form a plane surface between them.

In this embodiment, the multi-layered composite has a three-dimensional form, i.e. it extends basically in three spatial directions.

According to the invention, in this embodiment the at least one cover layer and the at least one core layer are arranged so that they define a plane between them which is not completely flat or planar.

In one embodiment, the multi-layered composite can be pressure deformed at the edges or, additionally thereto or separately therefrom, be pressure deformed at any points of the multi-layered composite.

For producing the multi-layered composite according to the third exemplary embodiment by means of pressure deformation, wherein three-dimensionally deformed objects are created, reference is made to the methods and conditions which are disclosed in DD 271670 and DE 101 24 912, which are hereby incorporated by reference in their entirety.

In the first, second and third exemplary embodiments of a multi-layered composite according to the invention, different materials can be used as in the at least one cover layer. Cover layers are preferably selected from: veneer, wooden board, chipboard, fibreboard, plywood board, plastic sheet, plasterboard, sheet metal plate, fibre cement board or from two or a plurality thereof.

In one embodiment, the cover layer can preferably consist of wood or comprise wood.

For particular applications, use can also be made of a cover layer which has openings, for example ventilation slots. The openings can be formed in an optional manner. Alternatively, the cover layer can even be dispensed with so that the open core layer structure forms the visible area. Such components are especially advantageous as sound insulation elements, but can also be used for air-permeable seating furniture, partitions or decorative elements.

The edges of the multi-layered composites according to the first, the second and the third exemplary embodiments of a multi-layered composite according to the invention can be pressure deformed, i.e. compressed, in order to seal the cavities at the edges of the composites. This method is already disclosed above in relation to the core layers according to the first, second and third exemplary embodiments. The pressure deformation (compression) can be carried out during the joining together of the layers, i.e. joining of the at least one cover layer to the core layer, but can also be carried out after the joining together of the layers in a subsequent step, for example by thermal softening of the adhesive on the edges. This embodiment has the advantage that sealing of the edges, for example by the attaching of a wooden strip, preferably a veneer strip, can be omitted.

These multi-layered composites according to the invention can furthermore have: means for fastening the core layer on the cover layer, preferably an adhesive; means for stiffening the composite; means for thermal insulation of the composite, preferably glass wool; means for fastening the composite on a support, preferably nails or screws; and/or fittings, preferably furniture fittings, for example handles.

The core layers according to the first, the second and the third exemplary embodiments, and also the multi-layered composites of the first, the second and the third exemplary embodiments, can be used in applications which require high mechanical stability in comparison to the weight. Furthermore, the core layers and multi-layered composites according to the invention can also be used in applications which require a high level of insulation.

In one embodiment, the core layers and multi-layered composites according to the invention are used in the production of furniture, in the production of shelving and packaging for transportation purposes, in interior work, for doors, for vehicles and in shipbuilding.

In a further embodiment, the core layers and multi-layered composites are used for sound-insulating construction elements or air-permeable chair seats.

To this end, the core layers or multi-layered composites can be further processed by cutting, sawing, planing, trimming and/or drilling according to known methods.

Advantages, features and applications of the present invention according to the first aspect can be derived from the following embodiments with reference to the drawings. The same designations stand for the same devices, unless specified otherwise.

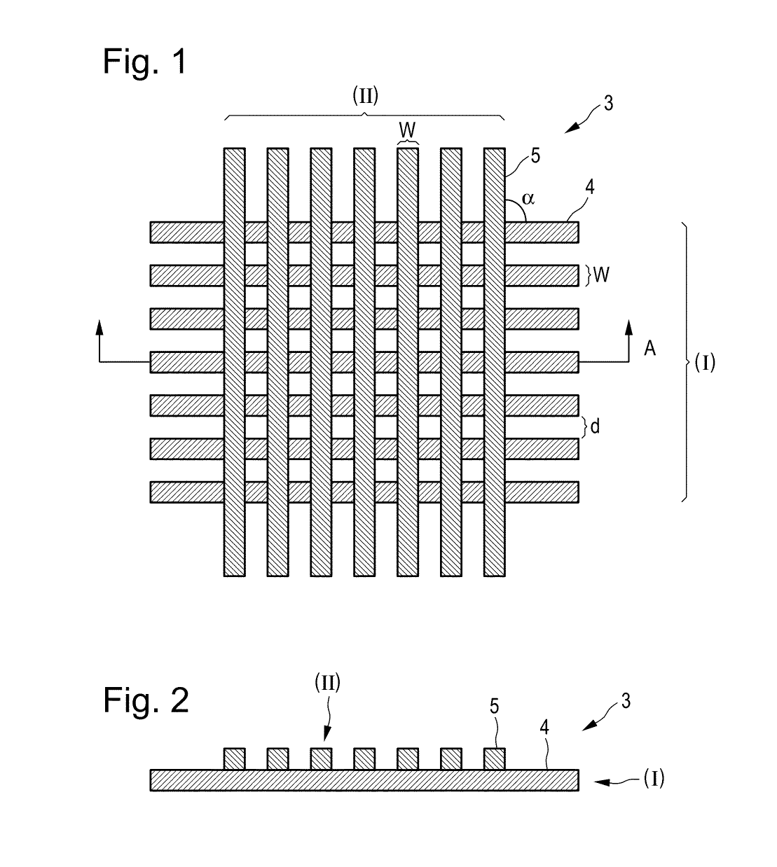

FIG. 1 shows a plan view of the core layer 3 of a preferred embodiment of the multi-layered composite according to the invention, preferably of a lightweight building board. The core layer 3 has a flat first layer (I), having straight first stick-like elements 4, and a flat second layer (II), having straight second stick-like elements 5, wherein the stick-like elements are wooden elements. The length of the stick-like elements runs basically parallel to the wood fibres, wherein all the stick-like elements in each layer are spaced apart, orientated parallel to each other, and separated from each other by a cavity in each case.

A first stick-like element 4 and a second stick-like element 5 include an angle α=90°.

Such a core layer 3 can be used to produce a multi-layered composite according to the invention, preferably a lightweight building board. This board has the advantages that 1) it has good shear rigidity and shear strength; 2) it allows a distance d between adjacent stick-like elements which can be equal to the width W of a stick-like element multiplied by a factor c selected from ranges with upper and lower limits according to {0.01; 0.1; 0.5; 1}≦c≦{0.5; 1; 5; 10}, which can be selected so that the following equation is satisfied: d=W·c, or especially d=W; 3) the cavities between stick-like elements form an interconnected system for ventilation. As a result, the moisture exchange in the board is accelerated. This is especially important when producing the board by pressing using aqueous adhesive and/or during the drying of the board since the adjustment to the equilibrium moisture content is achieved in shorter time in comparison to a board the core layer of which cannot be ventilated in the same way as with the core layer according to the invention; 4) when introducing a nail or a screw or a furniture connection, this meets a resistance to an adequate degree so that high fastening stability of the multi-layered composite on a support, for example on a wall, is provided.

FIG. 2 shows a cross section of the core layer of FIG. 1 along line A.

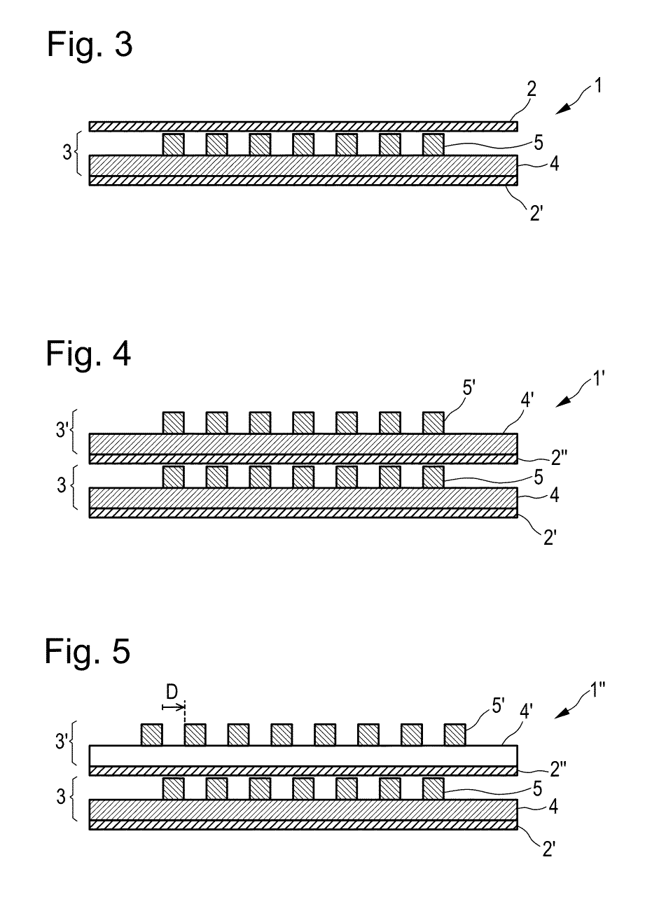

FIG. 3 shows a cross section of the multi-layered composite 1 with a cover layer 2 and a cover layer 2′, which are made from veneer, and which cover the core layer 3. These outer cover layers 2 and 2′ on both sides ensure additional mechanical stability of the multi-layered composite. The multi-layered composite 1 is relatively light and has an aesthetically attractive appearance on account of the cover layer consisting of veneer. The average density of the core layer is lower than the average density of the multi-layered composite 1.

FIG. 4 shows a cross section of the multi-layered composite 1′ which has a first core layer 3 and a second core layer 3′, which comprise stick-like elements 4, 5, 4′ and 5′ in each case, and a cover layer 2′ and a central cover layer 2″. Naturally, it is possible to also attach a cover layer to the stick-like elements 5′. Created as a result is a multi-layered composite which has outer cover layers on both sides. Outer cover layers on both sides increase the strength and stiffness in comparison to a multi-layered composite which has only one outer cover layer, that is to say only the outer cover layer 2′, for example.

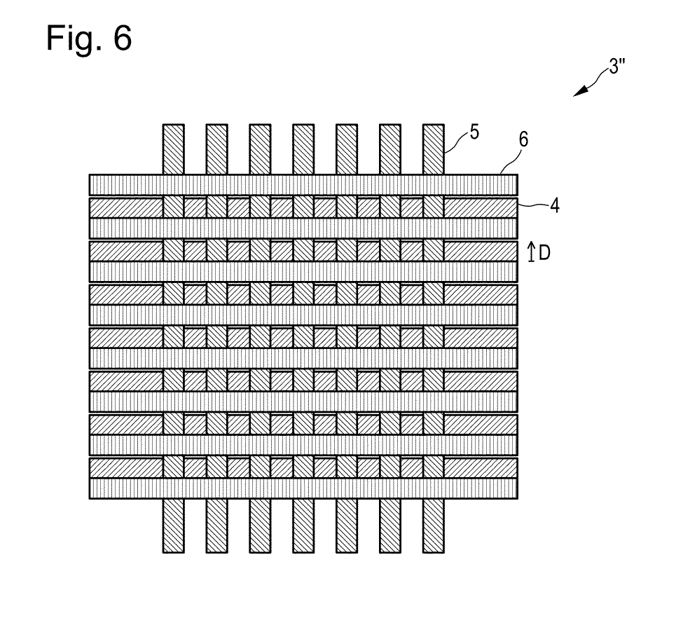

FIG. 5 shows a cross section of the multi-layered composite 1″ which is constructed similarly to the multi-layered composite 1′ of FIG. 4, but which has first stick-like elements 4′ (the contour is not indicated in FIG. 5) in the second core layer 3′ which is displaced, with regard to the first layer 3, in a direction which in this case is characterized in that it extends in the principal plane of the planar (flat) multi-layered composite 1″ and in a direction perpendicular to the straight length of the second stick-like elements 5 of the first core layer 3. Similarly to this, second stick-like elements 5′ of the second core layer 3′ are displaced with regard to the first core layer 3 in a direction which is characterized in that it extends in the principal plane of the planar multi-layered composite 1″ and in a direction perpendicular to the straight length of the first stick-like elements 4 of the first core layer 3. The distance d of the deflection is approximately equal to the distance between adjacent stick-like elements, i.e. D=d, and, preferably, D=W (W is the width of a stick-like element). As a result, a compact filling of the compressed core layers 3 and 3′ is brought about, wherein the board has good properties and mechanical stability for further working, for example for handling with nails and screws, for example for fastening the board or for fastening additional parts on the board. This is obvious if consideration is given to the arrangement according to FIG. 6 which is designed so that the projection of the stick-like elements of the core layer onto the principal plane of the board basically does not leave any open spaces. Furthermore, the stick-like wooden elements represent a lattice or a frame which has high stability against pressure action which acts perpendicularly to the principal plane of the board.

FIG. 6 shows a plan view of the core layer 3″ which has a first layer of first stick-like elements 4, a second layer of second stick-like elements 5 and a third layer of third stick-like elements 6. Like in FIG. 5, the third stick-like elements 6 are arranged parallel to the first stick-like elements but are displaced by a distance D.

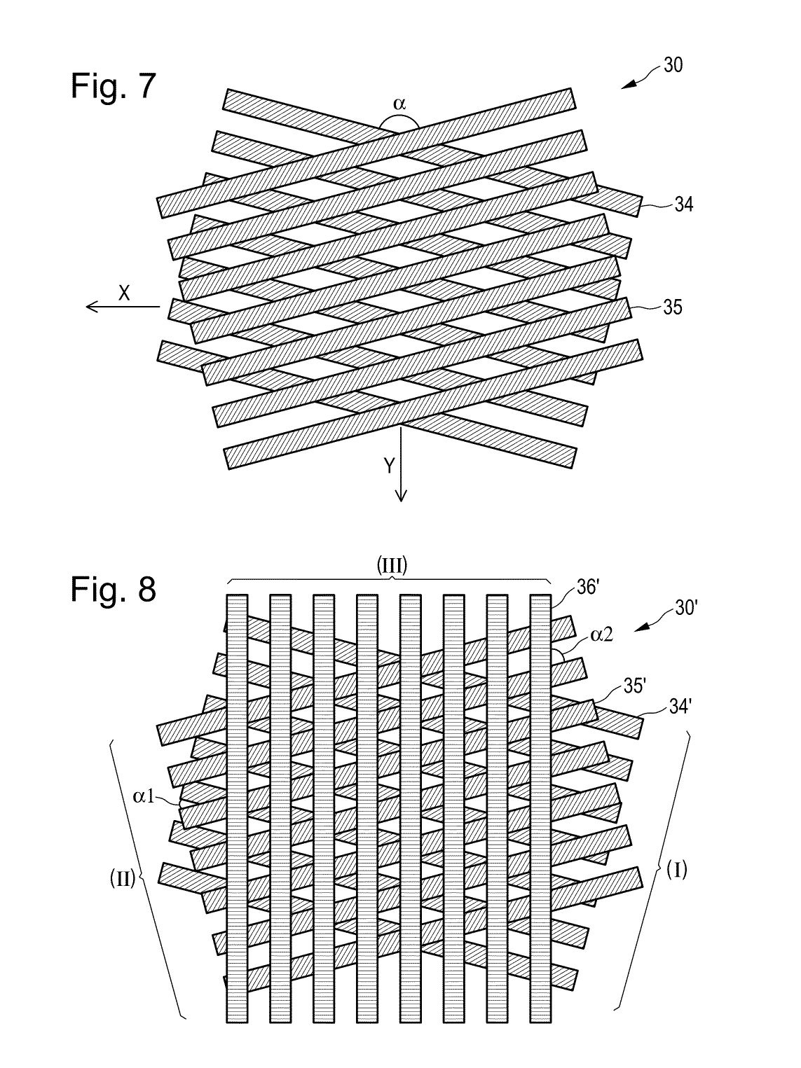

FIG. 7 shows a plan view of a core layer 30 which has a first layer of first stick-like elements 34 and a second layer of second stick-like elements 35, wherein the first stick-like elements 34 include an angle with the second stick-like elements 35 which is different from 90°, and which is approximately 120°. The resulting core layer has a preferred orientation X along which the multi-layered composite can withstand higher shear action which acts in the principal plane of the multi-layered composite in comparison to the direction Y. Such an arrangement of the core layer, which enables an asymmetrical arrangement of stick-like elements with regard to the angle and enables a preferred orientation, may be desirable for specific embodiments.

FIG. 8 shows a plan view of the core layer 30′ which has a first layer (I) of first stick-like elements 34′, a second layer (II) of second stick-like elements 35′ and a third layer (III) of third stick-like elements 36′. The first stick-like elements 34′ include an angle α1 with the second stick-like elements 35′ which is different from 90°, and in this case is approximately 60°, and the second stick-like elements 35′ include an angle α2 with the third stick-like elements 36′ which is different from 90°, in this case approximately 60°. In comparison to the core layer 30, the core layer 30′ has a symmetry with regard to the arrangement of stick-like elements and to the included angle αi and therefore preferably has no preferred orientation. This results in a higher anisotropy of the mechanical properties of the core layer, especially with regard to the effect of shear forces. In the same way, a number N of layers of stick-like elements i can be provided, wherein the stick-like elements of adjacent layers include an angle αi, wherein αi can be different and/or the same, wherein N is preferably selected from {2; 3; 4; 5; 6; 7; 8; 9; 10} or greater.

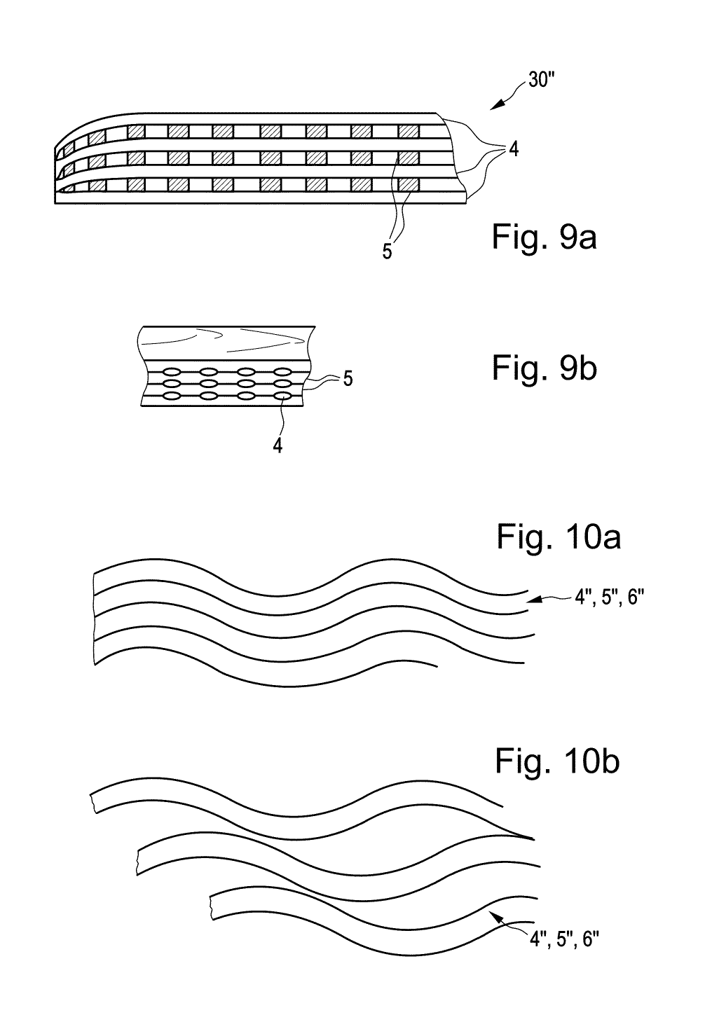

FIG. 9a shows a cross section of the compressed edge of a core layer 30″ according to the invention according to the third exemplary embodiment or of a multi-layered composite according to the invention according to the third exemplary embodiment, containing first stick-like wooden elements 4 and second stick-like wooden elements 5.

FIG. 9b shows a section of the compressed edge of the core layer 30″ according to the invention or of the multi-layered composite according to the invention of FIG. 9a.

FIG. 10a shows stick-like elements 4″, 5″, 6″, as used according to the invention, which are cut in a curve-like or waveform or corrugated manner.

FIG. 10b shows stick-like elements 4″, 5″, 6″ of FIG. 10a, which as a result of longitudinal displacement obtain an inevitably mutual spacing and form cavities between them. These elements can be used as first, as second and as third stick-like wooden elements.

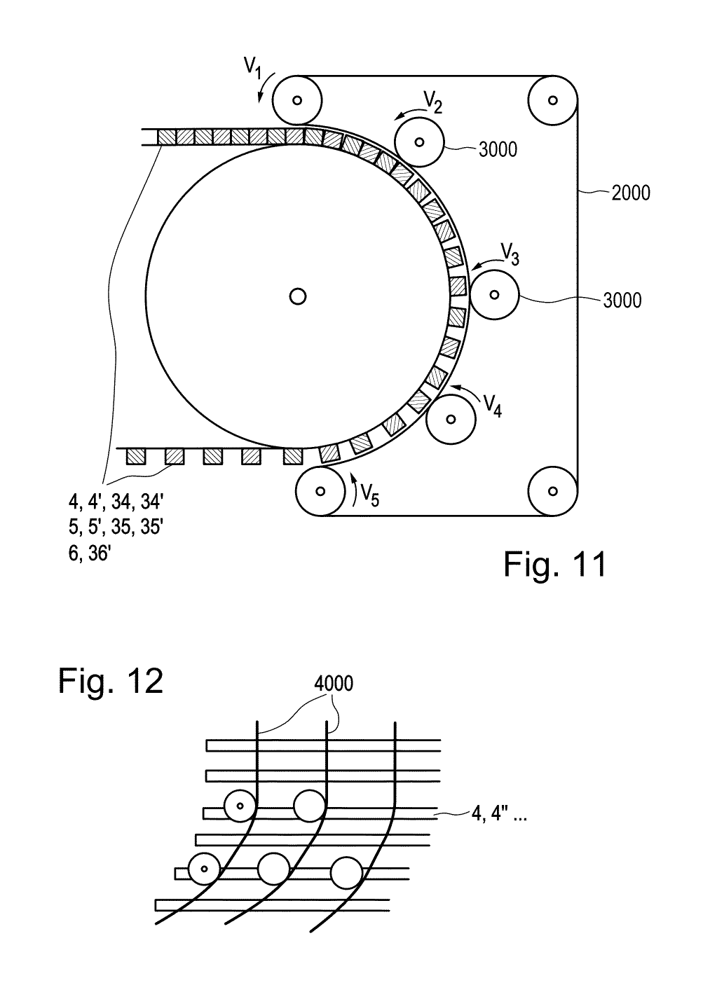

FIG. 11 shows a device for implementing a method for producing stick-like wooden elements. The wooden sticks are produced by cutting off wooden veneers, stacked one on top of the other, so that an endless band of wooden sticks, for example first wooden sticks 4, 4′, 34, 34′, or second wooden sticks 5, 5′, 35, 35′, or third wooden sticks 6, 36′, are created, these lying parallel next to each other and arranged transversely to the transporting direction. This endless band passes through a roller system which increases the transporting speed in steps until the wooden sticks have achieved the respectively desired distance from each other. If the wooden sticks should occupy an angle other than 90° to the transporting direction, a roller system, which alters the transporting direction in steps up to an angle of at most 45°, then follows. In this case, the wooden sticks remain in an arrangement parallel to each other. This open and possibly obliquely orientated lattice is then adhesively bonded to a carrier material such as non-woven fabric, cardboard or a veneer sheet. By laminating this lattice, a block according to the invention is created and can be used as a lightweight construction core (the term “lattice”, as used herein, means the arrangement according to the invention of first and second stick-like elements, also in combination with third stick-like wooden elements, preferably the arrangement as a result of positioning of the stick-like elements). Instead of a roller system for spreading apart the wooden sticks 1, use can also be made of elastic conveyor belts 2000, arranged in a modular fashion, which increasingly stretch during the progressive movement. The increasing stretching movement, symbolized in FIG. 11 by the increasing speed v₁ to v₅, is achieved by means of brakes or braking rollers 3000 acting upon the belt.

FIG. 12 shows that the oblique orientation of the wooden sticks of FIG. 11 can be achieved by means of correspondingly guided conveyor belts 4000. The spreading apart of the wooden sticks can also be achieved by means of stretchable carriers such as threads or foils, which are adhesively attached to the endless band in advance. The carrier is then stretched together with the adhesively attached wooden sticks.

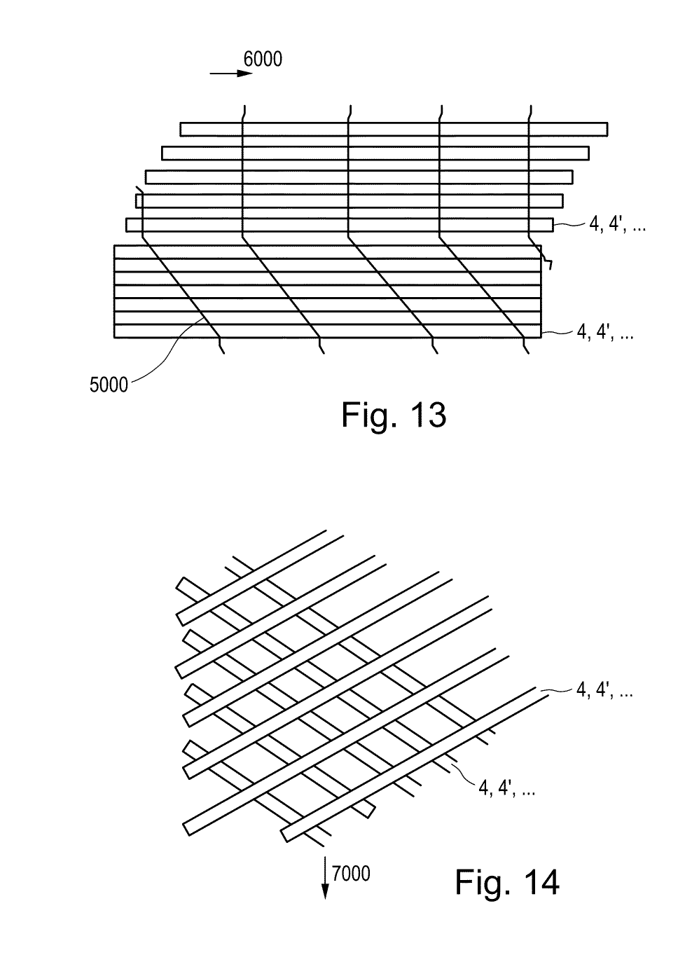

FIG. 13 shows that the spreading apart of the wooden sticks of FIG. 11 is possible by the endless band being glued to threads 5000, acting as carriers, which extend obliquely to the stick orientation. As a result of subsequent diagonal stretching 6000 of the endless band, the spacing of the wooden sticks is increased and at the same time an angle of the sticks which is less than 90° to the transporting direction is established. The adhesive attachment of the carrier threads by means of a plastic adhesive, such as so-called hot-melt adhesive which in the cold state also allows an angular displacement between thread and wooden stick, is a requirement for the stretching.

FIG. 14 shows an advantageous embodiment which manages without carrier material, in which at least two oppositely angled and open lattices of stick-like wooden elements are brought together and adhesively bonded to each other. The wooden sticks 4, 4′, which are arranged at an angle to the transporting direction 7000, enable a reliable guiding and gluing with known gluing rollers, for example. The adhesive bonding is carried out by means of known double band presses in the process. Thus, endless, crosswise-glued lattices are created and by means of multiple laminating can be adhesively bonded to form a lightweight construction core.

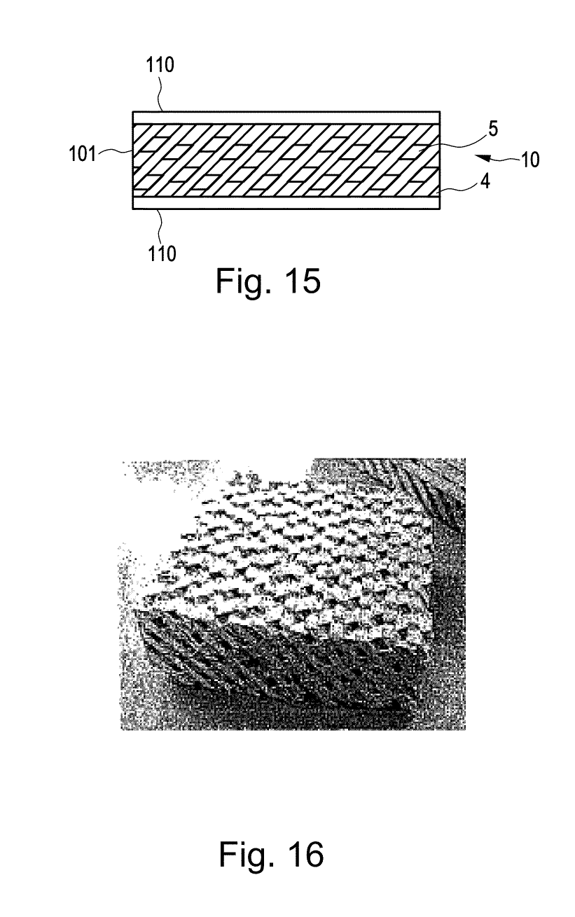

FIG. 15 shows a multi-layered composite 10 according to the invention, having the core layer 101 according to the second embodiment, from the side. In this case, first and second stick-like elements 4 and 5 of the layers (I) and (II) do not extend parallel to the cover layer 110 but form an angle with this. The stick-like elements preferably describe an angle of between 30° and 60° with a preferred angle of 45°.

FIG. 16 shows an image of the core layer 101 of the multi-layered composite 10 from FIG. 15.

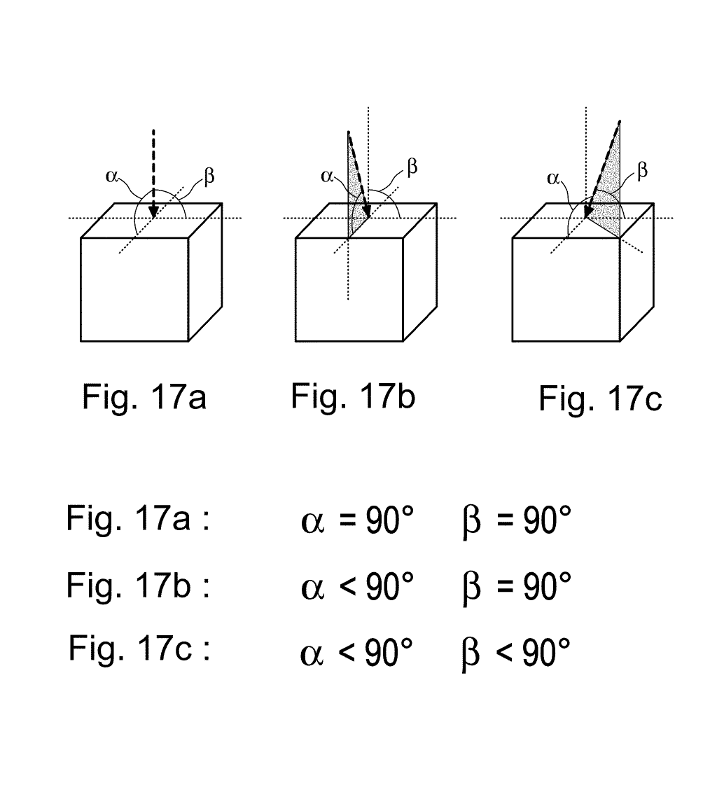

FIGS. 17a, 17b, and 17c show 3 stress patterns of a core layer according to the invention according to the second embodiment. FIG. 17a symbolizes the stress perpendicular (α=90° and β=90°) to a surface (broad surface or narrow surface) of a core layer, FIG. 17b symbolizes the stress at an angle of α<90° and β=90° to a surface (broad surface or narrow surface) of the core layer, and FIG. 17c symbolizes the stress at an angle of α<90° and β<90° to a surface (broad surface or narrow surface) of the core layer. The embodiment of FIG. 17a is the most frequent stress pattern, the embodiment of FIG. 17c is the most infrequent stress pattern. FIG. 17c is distinguished by the fact that both angles have a value which is less than 90°. Angles of between 30° and 60°, with a preferred variant of α=β=45°, are seen as being advantageous for the subsequent intended purpose.

It is furthermore shown as being advantageous that as a result of the double oblique positioning an oblique “first cutting” of each stick element which exists on the surfaces (narrow surface and broad surface) comes about. This brings about a surface enlargement without involvement of an increase of the mass. Conversely, this means that with a larger spacing of the stick elements of the individual open layers, which corresponds to a reduction of the weight, the same surface density with stick elements can be guaranteed (compared with open planes lying parallel to the respective cover layer).

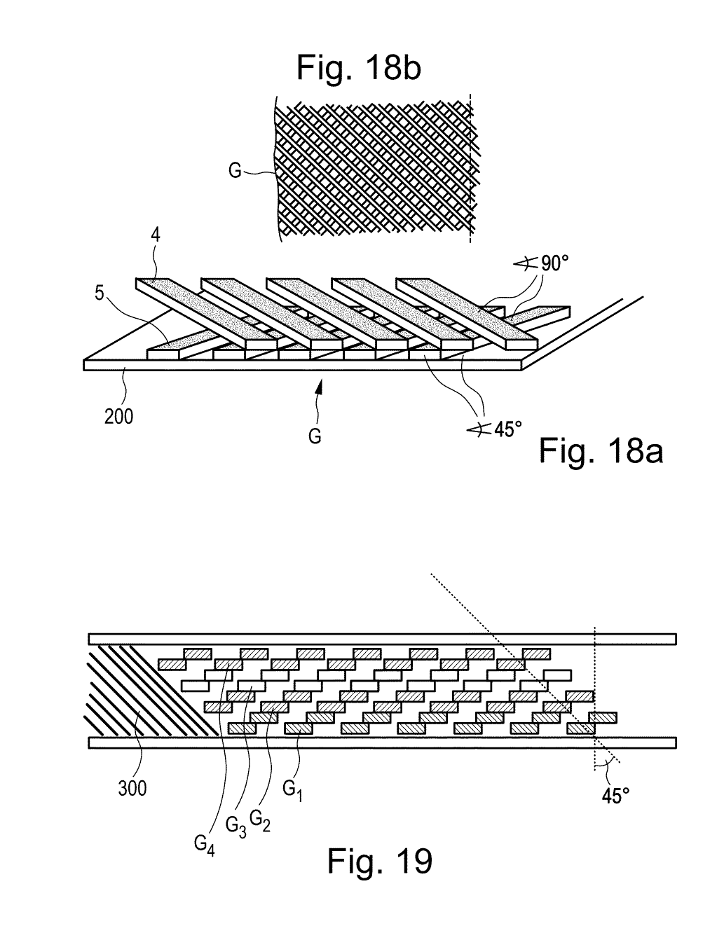

FIG. 18a schematically shows a method for producing a core layer according to the second embodiment. Developed first of all is a lattice G which is characterized in that two open layers (I) and (II), containing stick-like elements 4 and 5, are fixed and/or adhesively bonded one on top of the other. In this case, the stick-like wooden elements 4 and 5 of each layer are rotated in each case at an angle of 45-90° to the nearest abutting layers (preferably 90°) and also by 0-45° to the imaginary reference plane 200 (preferably 45° corresponding to a of FIGS. 17a-17c). These lattices are geometrically stable one beneath the other on account of the adhesive bonding of the open planes. FIG. 18b shows a plan view of the lattice of FIG. 18a.

FIG. 19 shows that according to the invention a multiplicity of lattices (Gᵢ) of FIGS. 18a-18b, preferably more than 50 pieces, can be brought together to form a block and can be fixed by means of gluing and pressing. In FIG. 19, four lattices G₁, G₂, G₃ and G₄ of FIGS. 18a-18b are schematically indicated. For minimizing a later waste or for increasing the degree of utilization, the joining together to form blocks is carried out in this case at an angle of 0 to 60°, preferably 45°. A complete pressing out of the lower layers can be carried out by the insertion of fitting pieces 300.

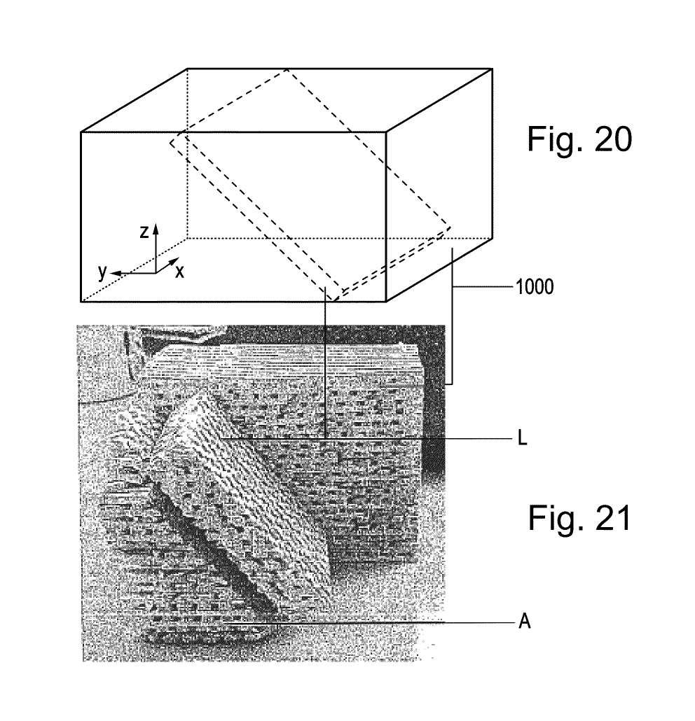

FIG. 20 schematically shows a block 1000, containing lattices Gᵢ, which is produced in such a way. A thus produced block, in addition to the above-described structures, is distinguished especially by the dimensions which are predetermined by the maximum dimensions of the multi-layered composite which are to be achieved. In this context, the block width (x-direction) determines the subsequent width of the multi-layered composite, and the block height (z-direction) determines the subsequent length of the multi-layered composite, preferably of lightweight building board. The block length (y-direction), which should be selected to be as large as possible in order to minimize first cut losses, determines how boards of a specific thickness can be produced from this block by cutting out. Descriptions of the block dimensions always refer to gross dimensions, i.e. that first cuts are to be taken into account.

FIG. 21 shows an image of a block 1000 with the position of the core layer L. The lattices Gᵢ are offset by 0° and joined together to form a block 1000. The core layer L has been separated from the block by cutting out at an angle of 45°. As a result of the separating of the core layer L at an angle of between 30° and 60° (preferably 45° corresponding to β of FIGS. 17a-17c, it is ensured that the most unfavourable position of all the cavities, as described further above, is to be found in the least frequent stress pattern of FIG. 17c.

### LIST OF DESIGNATIONS FOR FIGS. 1-21

1, 1′, 1″, 10 Multi-layered composite
2, 2′, 2″, 110 Cover layer
3, 3′, 3″, 30, 30′, 30″, 101 Core layer
4, 4′, 34, 34′, 4″ First stick-like elements
5, 5′, 35, 35′, 5″ Second stick-like elements
6, 36′, 6″ Third stick-like elements
1000 Block
2000 Elastic conveyor belt
3000 Braking rollers
4000 Conveyor belt
5000 Threads
6000 Diagonal stretch direction
7000 Transporting direction
200 Reference plane
300 Fitting pieces
G Lattice

Second Aspect of the Invention

Core layers according to the invention having wooden elements according to the invention, which have recesses, and multi-layered composites according to the invention containing the core layers.

According to a second aspect, an object is achieved according to the invention with a core layer which is suitable for a multi-layered composite which has at least one cover layer and the core layer, wherein the cover layer is arranged so that it at least partially covers the core layer and is fixedly connected to this, and with the multi-layered composite having the core layer, wherein the core layer has at least one wooden element which has at least one recess.

Wooden Element

Accordingly, the invention relates to a wooden element having at least one recess which is created by local opening of the surface of the wooden element, wherein the opening is carried out so that the opening direction of the recess extends parallel to the wood fibres of the wooden element.

In one embodiment, the wooden elements are stick-like. The term “stick-like” is defined in this case as described under the first aspect of the invention.

The term “local opening” means that not the complete surface of the at least one wooden element is opened in order to form at least one recess, but only a part thereof. The term also means that the surface of the wooden element can be opened at one position or at a plurality of positions.

The local opening of the surface of the wooden element can be effected by any known method which is suitable for creating a recess, or recesses. The recess is preferably created by a mechanical method.

In a preferred embodiment, the at least one recess can be created by the mechanical action being carried out so that the opening direction is effected parallel to the fibre orientation in the wooden element.

The term “wherein the opening direction extends parallel to the wood fibres of the wooden element” implies that the wood fibres in the wooden element have a preferred orientation. The term also implies that the fibres in said wooden element do not extend isotropically, i.e. they do not in essence extend in two or three spatial directions, but basically extend anisotropically, i.e. in one spatial direction.

Accordingly, the term “wherein the opening direction extends parallel to the wood fibres of the wooden element” can be used synonymously to terms like “wherein the opening direction extends parallel to the preferred orientation of the wood fibres of the wooden element” or “wherein the surface is opened parallel to the wood fibres of the wooden element” or “wherein the surface is opened locally parallel to the preferred orientation of the wood fibres in the wooden element” or “wherein the surface is opened locally parallel to the wood fibres of the wooden element” or “wherein the surface is opened locally parallel to the preferred orientation of the wood fibres of the wooden element”.

The forming of the at least one recess is preferably carried out by means of a pretreatment of a wooden element, wherein the pretreatment facilitates opening of the wood surface parallel to the preferred orientation of the fibres.

In one embodiment, the pretreatment can be carried out so that the surface of a wooden element is notched in order to create predetermined breaking points. Such an embodiment has the advantage that it is no longer necessary to effect the local opening by means of breaking open using a sufficient stretching or opening out force but by means of a bending deformation. The notching can be carried out with the aid of punching tools or by means of rotating knives. Such devices are known in the field of woodworking.

In a further embodiment, the pretreatment can be carried out so that a wooden element is guided through a roller pair which has different circumferential speeds.

In a further embodiment, the pretreatment can be carried out so that the surface of a wooden element is cut into over the entire thickness of the wooden element.

The at least one recess is preferably formed by the wooden element being opened out in opposite directions by force action at the pretreated points. In this case, the force action does not extend parallel to the fibre orientation of the wooden element. The recess is preferably formed by the wooden element being opened out in opposite directions which lie transversely to the fibre orientation of the wooden element. It is especially preferred that the stretching force lies perpendicularly to the fibre orientation. The term “open out”, as used herein, is used synonymously to the term “spread open”.

In one embodiment, the predetermined breaking points can be provided with grooves. This allows a further simplified opening of the surface at the predetermined breaking points.

The term “grooves”, as used in this context, also embraces the term “notches”.

Alternatively or in addition to this, the wooden element can be cut into over the entire thickness in the direction of the thickness of the wooden element. For cutting in, suitable blades are known from the field of woodworking.

Alternatively or in addition to this, the opening of the surface of the wooden element can be facilitated by means of a stretching device. A suitable device preferably has a roller pair, wherein the rollers have different circumferential speeds.

Accordingly, the method according to the invention for producing a wooden element according to the invention, which has at least one recess, has at least one of, or a plurality of, the following steps (i) to (iii), and in addition has the step (iv):
(i) notching of the surface of the wooden element in order to create predetermined breaking points;
(ii) cutting in of the wooden element over the entire thickness in the direction of the thickness of the wooden element;
(iii) guiding of the wooden element through a roller pair, wherein the rollers have different circumferential speeds;
(iv) according to one of, or to a plurality of, the steps (i) to (iii), opening of the surface parallel to the preferred orientation of the fibres in the wooden element in order to create a recess.

In addition, the method according to the invention can also have a step which is designed to provide the predetermined breaking points with grooves.

After the forming of the at least one recess, fixing of this recess may be necessary on account of restitution forces. Restitution forces in the wooden element can exist if the wooden element is elastically deformed principally by means of the stretching force.

Accordingly, the method according to the invention for producing the wooden element according to the invention can additionally have the step (v) after step (iv):
(v) fixing of the recess formed in step (iv).

In one embodiment, the restitution can be largely prevented by the wooden element, which has the recess, being dried.

In a further embodiment, the stretching or opening out is carried out so that the deformation, which is effected as a result of the stretching or opening out, is a plastic deformation, or a largely plastic deformation, i.e. the stretching or opening out exceeds the range of the elastic deformation. A plastic deformation is facilitated as a result of a high moisture content of the wood and as a result of a high temperature. Such a plastic deformation can be further facilitated and enabled as a result of an exact orientation with the aid of grooves at the corresponding predetermined breaking points.

In a further embodiment, the shape of the recess can be maintained by means of a clamping device. In one embodiment, a clamping device is used in the event of predominantly elastic deformation.

Accordingly, in one embodiment of the method according to the invention for producing wooden elements according to the invention, step (v) can have one of, or a plurality of, the steps (v′) to (v″′):
(v′) fixing of the recess formed in step (iv) by drying of the wooden element;
(v″) fixing of the recess formed in step (iv) by plastic deformation of the wooden element;
(v″′) fixing of the recess formed in step (iv) by means of a clamping device.

Alternatively to the cutting in of the veneers, veneers can be stacked to form a wooden block and in this case can be connected in each case transversely to the wood fibre orientation by means of adhesive applied in strips. These strips are staggered from veneer layer to veneer layer in each case. From this wooden block, veneer sheets, possibly as endless veneer sheets, are cut off transversely to the veneer surface and also approximately parallel to the wood fibre orientation. This veneer sheet can be spread out by means of a mechanical stretching mechanism by wave-like deformation of the individual strip-form wooden elements, wherein the wooden elements stick together at the adhesion points in each case.

According to an advantageous variant, the veneer sheets, during the cutting off, are notched in each case near to the adhesively fastened regions by means of a scoring knife in order to obtain predetermined breaking points. During the stretching of the veneer sheets, a kinked structure is created and is adjustable within wide limits depending upon the desired degree of opening.

Accordingly, the invention also relates to a wooden element, at least having one recess, which is characterized in that it can be produced by means of the method according to the invention.

In a particular embodiment, the wooden elements are of a stick-like design. They can then be used according to the invention in the embodiments of the core layer and of the multi-layered composite, as defined in the first aspect of the invention, as first and second stick-like elements in the first and second layers (I) and (II).

The wooden element according to the invention, having at least one recess, for example a stick-like wooden element, can preferably be produced from a veneer or from an oriented strand board (OSB) chip.

Core Layer Having Wooden Elements

According to the invention, the wooden elements can be processed so that they form a core layer. The core layer can have just one wooden element according to the invention, as well as a plurality of wooden elements according to the invention.

In one embodiment, wooden elements can be adhesively fastened one on top of the other over the whole area or in strips, in layers and preferably crosswise, in order to form a core layer.

In one embodiment, wooden elements according to the invention are stacked one on top of the other and adhesively bonded to form a core layer. In one embodiment, the core layer has a stack comprising wooden elements according to the invention which are adhesively fastened together.

The wooden elements are preferably stacked one on top of the other so that the fibre orientations of two adjoining wooden elements together include an angle of 90°.

In a further embodiment, it is also possible to irregularly arrange, and then to adhesively fasten together, the wooden elements in the core layer.

Accordingly, the invention also relates to a core layer which is suitable for a multi-layered composite which has at least one cover layer and the core layer, wherein the cover layer is arranged so that it at least partially covers the core layer and is fixedly connected to this, having at least one wooden element according to the invention.

In one embodiment, the core layer has a wooden element, or the core layer has a stack of wooden elements according to the invention, arranged one on top of the other, which are adhesively bonded to each other; or the core layer has wooden elements according to the invention which are arranged in an optional manner, wherein the wooden elements are adhesively bonded together.

The invention also relates to a method for producing a core layer according to the invention, wherein the method has at least the steps (i) and (ii):
(i) arranging of the wooden elements according to the invention in such a way that wooden elements are in mutual contact;
(ii) adhesive bonding of the contacting wooden elements.

The wooden elements can be orientated manually or by machine for producing the core layer according to step (i).

In one embodiment, the wooden elements according to the invention are arranged on a cover layer. This embodiment is then also characterized in that the arranging of step (i) on a cover layer is carried out, and in that in step (ii) the wooden elements are additionally adhesively bonded to the cover layer.

For the adhesive bonding according to step (ii), use can be made of the adhesive which is customarily used in woodworking. The adhesive effect can be assisted by applying pressure, preferably with the aid of a pressing device.

Accordingly, the invention also relates to a core layer which is suitable for a multi-layered composite which has at least one cover layer and the core layer, wherein the cover layer is arranged so that it at least partially covers the core layer and is fixedly connected to this, having wooden elements according to the invention which can be produced by means of a method which has at least the steps (i) and (ii):
(i) arranging of the wooden elements according to the invention in such a way that wooden elements are in mutual contact;
(ii) adhesive bonding of the contacting wooden elements.

The core layer can also be subjected to a pressure deformation according to the methods which are described in the first aspect of the invention, preferably by it being subjected to a pressure deformation in a suitable pressing device.

In one embodiment, the pressure deformation can be carried out during the implementation of steps (i) and (ii) or according to step (ii).

Accordingly, the invention also relates to a method for producing a core layer, additionally having the step (iii):
(iii) pressure deforming of the core layer obtained in step (ii),

wherein steps (ii) and (iii) are carried out at the same time or consecutively.

In one embodiment, the core layer can be pressure deformed at the edges or, additionally thereto, or separately therefrom, at any points of the core layer.

The invention also relates to a core layer which is suitable for a multi-layered composite which has at least one cover layer and the core layer, wherein the cover layer is arranged so that it at least partially covers the core layer and is fixedly connected to this, having wooden elements according to the invention which can be produced by means of a method which comprises the steps (i) to (iii):
(i) arranging of the wooden elements according to the invention in such a way that wooden elements are in mutual contact;
(ii) adhesive bonding of the contacting wooden elements;
(iii) pressure deforming of the core layer obtained in step (ii), wherein steps (ii) and (iii) can be carried out at the same time or consecutively.

Multi-Layered Composite Having a Core Layer Comprising Wooden Elements

Furthermore, the invention also relates to a method for producing a multi-layered composite which has at least one cover layer and the core layer according to the invention, wherein the cover layer is arranged so that it at least partially covers the core layer and is fixedly connected to this, wherein the core layer has at least one wooden element according to the invention which has the steps (i) and (ii):
(i) arranging of a cover layer in such a way that it at least partially covers the core layer according to the invention, wherein the core layer has at least one wooden element according to the invention;
(ii) fastening of the cover layer on the core layer.

The fastening in step (ii) is preferably carried out by adhesive bonding and, if necessary, by applying pressure.

Alternatively to this, the multi-layered composite according to the invention can be produced according to a method which has at least the steps (i) and (ii):

(i) arranging of wooden elements according to the invention in such a way that wooden elements are in mutual contact, wherein the arranging on a cover layer is carried out;
(ii) adhesive bonding of the contacting wooden elements; and adhesive bonding of wooden elements to the cover layer of step (i).

The arranging according to step (i) can be carried out either by machine or by means of a manual operation.

Suitable adhesives are known from the field of woodworking. The adhesive bonding under pressure is carried out preferably within a range of between 0.002 MPa and 1.5 MPa, preferably within a range of between 0.01 MPa and 1.0 MPa.

In one embodiment, the invention relates to a multi-layered composite which has at least one cover layer and a core layer, wherein the cover layer is arranged so that it at least partially covers the core layer and is fixedly connected to this, wherein the core layer is a core layer according to the invention according to the second aspect.

In a further embodiment, the invention relates to a multi-layered composite which has at least one cover layer and a core layer, wherein the cover layer is arranged so that it at least partially covers the core layer and is fixedly connected to this, and can be produced according to a method which has at least the steps (i) and (ii):
(i) arranging of wooden elements according to the invention in such a way that wooden elements are in mutual contact, wherein the arranging on a cover layer is carried out;
(ii) fastening of the contacting wooden elements; and fastening of wooden elements to the cover layer of step (i).

In this embodiment, the cover layer is preferably planar.

Naturally, the core layer according to the invention can also be arranged between two cover layers.

In a further embodiment, the multi-layered composite according to the invention having the planar cover layer can be pressure deformed. Suitable methods are disclosed under the first aspect of the invention.

In one embodiment, the multi-layered composite according to the invention can be pressure deformed at the edges or, additionally thereto or separately therefrom, at any points of the multi-layered composite.

Accordingly, in this embodiment the invention relates to a multi-layered composite which has at least one cover layer and a core layer, wherein the cover layer is arranged so that it at least partially covers the core layer and is fixedly connected to this, wherein the core layer represents a core layer according to the invention and can be produced by means of a method which has at least the step (i):
(i) pressure deforming of the multi-layered composite according to the invention having a planar cover layer.

The at least one cover layer preferably features a material which is selected from the group: veneer, wooden board, chipboard, fibreboard, plywood board, plastic sheet, plasterboard, sheet metal plate, fibre cement board, or two or a plurality thereof.

Advantages, features and applications of the present invention according to the second aspect can be derived from the following embodiments with reference to the drawings.

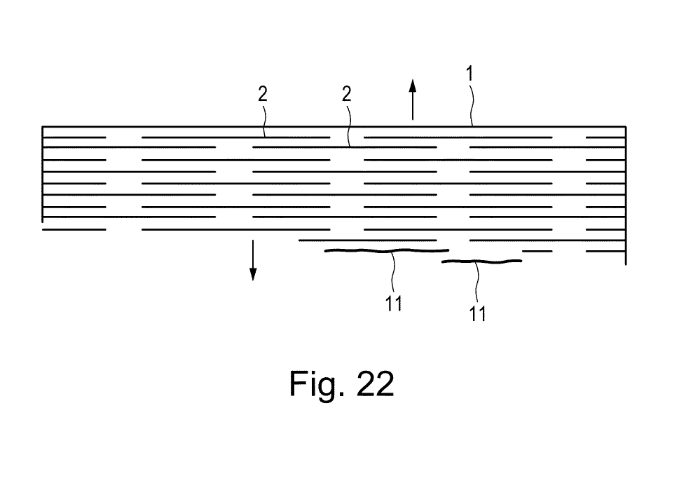

FIG. 22 shows a wood surface with predetermined breaking points of a wooden element 1 according to the invention. In this case, predetermined breaking points or predetermined breaking lines 2 have been created by notching of the surface of the wood before the local opening of the surface of the wooden element. The predetermined breaking points or predetermined breaking lines 2 extend parallel to the fibre orientation 11. The arrows indicate the preferred opening out direction. The predetermined breaking points are opened out in opposite directions, wherein the opening out direction extends perpendicularly to the fibre orientation 11 of the wooden element 1 in each case. Accordingly, the opening direction of the surface of the wooden element extends parallel to the wood fibres.

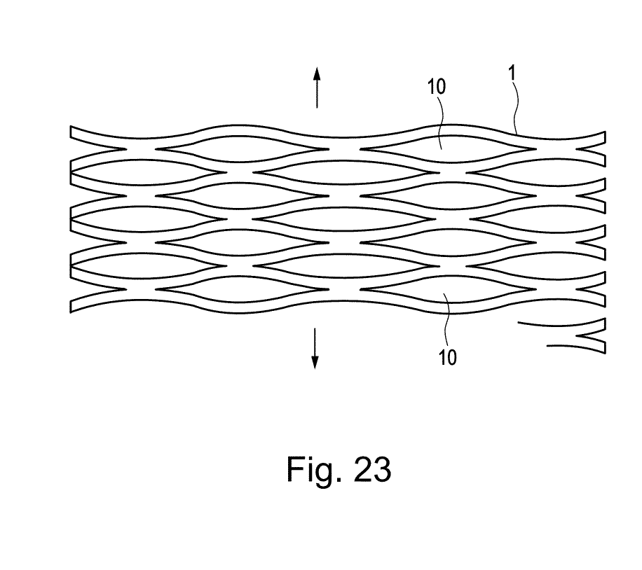

FIG. 23 shows a wooden element 1 according to the invention, wherein the wooden element 1 has been cut into over the entire thickness in the direction of the thickness of the wooden element 1. For cutting in, a punching tool or a rotating knife can be used. In this embodiment, breaking open of the wooden element 1 is not necessary in order to create the recesses. A deformation by bending of the formed structure is sufficient in order to form the recesses 10. The arrows indicate the preferred opening out direction which lies perpendicularly to the fibre orientation of the wooden element 1 in each case.

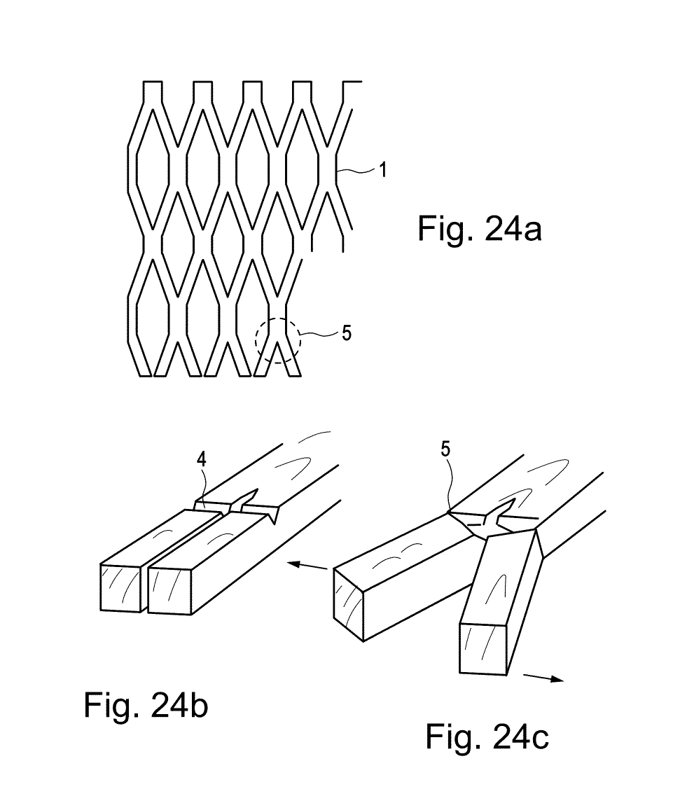

FIG. 24a shows a further embodiment of a wooden element 1 according to the invention, wherein the opening out of a predetermined breaking point 5 results in a plastic deformation. Said plastic deformation, especially a deformation by bending, can be further facilitated by means of grooves 4 (FIG. 24b) at predetermined breaking points 5 (FIG. 24a, FIG. 24c). Accordingly, the deformation location by bending can be accurately positioned.

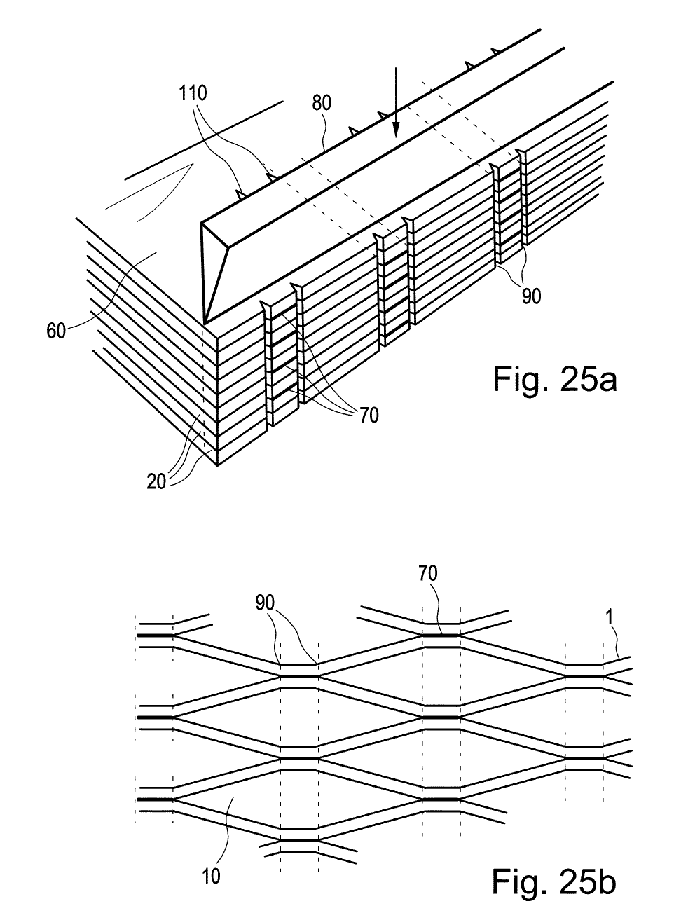

FIG. 25a shows a stack of veneers 20 which form a block 60. The veneers 20 are interconnected in a direction which lies transversely to the fibre orientation. The connecting means is an adhesive on bonding sections or bonding strips 70, wherein the adhesive has been applied in each case in a strip-like manner. These strips 70 are displaced from layer to layer in each case. Layers of veneers are cut using a knife 80, wherein the knife orientation lies transversely with regard to the veneer surface and parallel, or approximately parallel, to the fibre orientation of the wood. The veneers can be provided in the form of an endless band. This veneer band is drawn through a mechanical stretching device, with waveform deformation of the formed individual strip-like wooden elements, where the wooden elements are joined together in each case at the corresponding adhesive sections or adhesive strips 70. In a preferred embodiment, the veneers, during the cutting off in each case next to the adhesively fastened sections by means of a knife, preferably a scoring knife 110, are provided with a groove 90. Accordingly, predetermined breaking points or predetermined breaking lines are created, assisting the formation of the recess (FIG. 25a, FIG. 25b).

### LIST OF DESIGNATIONS FOR FIGS. 22-25B

1 Wooden element
2 Predetermined breaking line
4 Groove
5 Predetermined breaking point
10 Recess
11 Fibre orientation
20 Stacked veneers
60 Block consisting of stacked veneers
70 Adhesive
80 Knife
90 Groove
110 Scoring knife

Third Aspect of the Invention

Core layers according to the invention having wooden elements which are arranged irregularly in the core layer, and multi-layered composites according to the invention containing the core layers.

According to a third aspect, the object according to the invention is achieved with a core layer which is suitable for a multi-layered composite which has at least one cover layer and the core layer, wherein the cover layer is arranged so that it at least partially covers the core layer and is fixedly connected to this, and with the multi-layered composite having the core layer, wherein the core layer has wooden elements which are arranged irregularly in the core layer.

According to the invention, for producing the core layer use is made of wooden elements which have at least two stick-like wooden elements which are interconnected.

Wooden Elements

In one embodiment, the at least two stick-like wooden elements are spaced apart by a cavity, wherein the at least two stick-like elements are interconnected by means of a carrier material.

The carrier material is preferably selected from: threads, threads arranged in a grid-like manner, non-woven fabric, woven fabric, foil, fusible plastic, or hot-melt adhesive.

Accordingly, in one embodiment the invention relates to a wooden element having at least two stick-like wooden elements which are spaced apart by a cavity, wherein the at least two stick-like wooden elements are interconnected by means of a carrier material.

The wooden element having at least two stick-like wooden elements, which are to be spaced apart by means of a carrier material, can be produced according to a method which has at least one of the steps (i) or (ii) and the step (iii):
(i) stacking of veneers to form a wooden block and cutting of the wooden block transversely to the veneer surface and parallel to the fibre orientation of the veneer in such a way that stick-like wooden elements are obtained; or
(ii) rotary peeling of veneers, wherein the veneer is cut transversely to the veneer surface and parallel to the fibre orientation of the veneer in such a way that stick-like wooden elements are obtained;
(iii) connecting of at least two of the stick-like wooden elements, which are obtained in (i) or (ii), by means of a carrier material in such a way that the at least two stick-like wooden elements are spaced apart.

In a further embodiment, use can be made of a wooden element according to the invention which has at least two stick-like wooden elements, wherein the at least two stick-like wooden elements intersect, wherein they are interconnected at the intersection point by means of an adhesive.

The intersecting stick-like wooden elements, which are adhesively bonded to each other at the intersection point, can be produced by stick-like wooden elements being first provided in a loose bulk without the use of a binding material, as is known in the production of matches. After the subsequent drying and gluing, these sticks, by means of a spreading and straightening mechanism, in an angular range of >0° to 90° to each other, are formed into a mat and then adhesively bonded to each other in the process. This endless mat, in which the cohesion of the sticks is created by means of adhesive bonding at the intersection points, can then subsequently be split up to a desired size by means of a cutting tool.

Accordingly, in this embodiment the wooden elements which are used for the production of the core layer can be produced according to a method which has at least the steps (i) to (iii):
(i) arranging of stick-like wooden elements in a loose bulk;
(ii) adhesive bonding of the stick-like wooden elements in an angular range >0° to 90° to each other to form a mat;
(iii) dividing up of the mat.

In a further embodiment, it is also possible, by means of a technology known from the manufacture of matches, to form from a loose bulk of wooden sticks a regular lattice comprising wooden sticks which are equally spaced apart and to fix these with the aforesaid binding materials. Similarly, at least two regular lattices can be adhesively bonded together if the stick orientations of the lattices differ from each other by at least 10°.

The lengths of the stick-like wooden elements in the wooden elements according to the invention are preferably selected so that they lie within the range of between 0.5 and 10 cm or within the range of between 1 cm and 5 cm.

The cross-sectional areas of the stick-like wooden element are preferably selected so that they lie within the range of between 0.01 cm² and 1 cm².

The stick-like wooden elements preferably have the same shape, length and cross-sectional area.

Core Layers

A further object of the invention is a core layer having the wooden elements according to the invention.

In one embodiment, the invention relates to a core layer which is suitable for a multi-layered composite which has at least one cover layer and the core layer, wherein the cover layer is arranged so that it at least partially covers the core layer and is fixedly connected to this, wherein the core layer has wooden elements which are arranged irregularly in the core layer, wherein the wooden elements are wooden elements according to the invention having at least two interconnected stick-like wooden elements, or wooden elements which have been produced according to the invention.

In one embodiment, the invention relates to a core layer which is suitable for a multi-layered composite which has at least one cover layer and the core layer, wherein the core layer is arranged so that it at least partially covers the core layer and is fixedly connected to this, wherein the core layer has wooden elements which are arranged irregularly in the core layer, wherein the wooden elements have at least two wooden elements which are spaced apart by a cavity and are interconnected by means of a carrier material.

In a further embodiment, the invention relates to a core layer which is suitable for a multi-layered composite which has at least one cover layer and the core layer, wherein the cover layer is arranged so that it at least partially covers the core layer and is fixedly connected to this, wherein the core layer has wooden elements which are arranged irregularly in the core layer, wherein the wooden elements have at least two intersecting stick-like wooden elements which are adhesively bonded to each other at the intersection point.

The core layer according to the invention can be produced according to a method having at least the steps (i) and (ii):
(i) arranging of the wooden elements according to the invention, or arranging of the wooden elements which are produced according to the invention, in such a way that they are irregularly distributed; and
(ii) adhesive bonding of the wooden elements which are arranged irregularly in step (i).

Wooden elements are preferably arranged in step (i) so that wooden elements are in mutual contact.

In one embodiment, the wooden elements according to the invention are arranged on a cover layer. This embodiment is then characterized in that the arranging of step (i) is carried out on a cover layer, and in that in step (ii) the wooden elements are also adhesively bonded to the cover layer.

For the adhesive bonding according to step (ii), use can be made of the adhesive which is customarily used in woodworking. The adhesive effect can be assisted by applying pressure, preferably with the aid of a pressing device.

Accordingly, the invention also relates to a core layer which is suitable for a multi-layered composite which has at least one cover layer and the core layer, wherein the cover layer is arranged so that it at least partially covers the core layer and is fixedly connected to this, having wooden elements which are produced according to the invention and can be produced by means of a method which has at least the steps (i) and (ii):
(i) arranging of the wooden elements according to the invention, or arranging of the wooden elements which are produced according to the invention, in such a way that they are irregularly distributed; and
(ii) adhesive bonding of the wooden elements which are irregularly arranged in step (i).

The core layer which is obtained in step (ii) can also be pressure deformed, as described in the first aspect of the invention.

In one embodiment, the core layer can be pressure deformed at the edges or, additionally thereto, or separately therefrom, at any points of the core layer.

Accordingly, the method according to the invention can additionally have the step (iii):
(iii) pressure deforming of the core layer which is obtained in step (ii), wherein step (iii) can be carried out after step (ii) or at the same time with step (ii).

Multi-Layered Composites

The invention furthermore also relates to a method for producing a multi-layered composite which has at least one cover layer and the core layer according to the third aspect, wherein the cover layer is arranged so that it at least partially covers the core layer and is fixedly connected to this, which method has at least the steps (i) and (ii):
(i) arranging of a cover layer in such a way that it at least partially covers the core layer according to the invention;
(ii) fastening of the cover layer on the core layer.

The arranging according to step (i) can be carried out either by means of a manual operation or by machine. The fastening in step (ii) is preferably carried out by adhesive bonding and, if necessary, by applying pressure.

Suitable adhesives are known from the field of woodworking. The adhesive bonding under pressure is carried out preferably within a range of between 0.002 MPa and 1.5 MPa, preferably within a range of between 0.01 MPa and 1.0 MPa.

In one embodiment, the invention relates to a multi-layered composite which has at least one cover layer and a core layer, wherein the cover layer is arranged so that it at least partially covers the core layer and is fixedly connected to this, wherein the core layer is a core layer according to the invention according to the third aspect.

In a further embodiment, the invention relates to a multi-layered composite which has at least one cover layer and a core layer, wherein the cover layer is arranged so that it at least partially covers the core layer and is fixedly connected to this, and can be produced according to a method which has at least the steps (i) and (ii):
(i) arranging of wooden elements according to the invention in such a way that wooden elements are in mutual contact, wherein the arranging on a cover layer is carried out;
(ii) fastening of the contacting wooden elements; and fastening of wooden elements to the cover layer of step (i).

The fastening is preferably carried out by means of an adhesive.

The cover layer is preferably planar.

Naturally, the core layer according to the invention can be arranged between two cover layers.

In a further embodiment, the multi-layered composite according to the invention, having the planar cover layer, can be pressure deformed. Suitable methods are disclosed under the first aspect of the invention.

Accordingly, in this embodiment the invention relates to a multi-layered composite which has at least one cover layer and a core layer, wherein the cover layer is arranged so that it at least partially covers the core layer and is fixedly connected to this, wherein the core layer represents a core layer according to the invention and can be produced by means of a method which has at least the step (i):
(i) pressure deforming of a multi-layered composite according to the invention having a planar cover layer.

In one embodiment, the multi-layered composite according to the invention can be pressure deformed not only at the edges but additionally thereto, or separately therefrom, at any points of the multi-layered composite.

The at least one cover layer preferably features a material which is selected from the group: veneer, wooden board, chipboard, fibreboard, plywood board, plastic sheet, plasterboard, sheet metal plate, fibre cement board, or two or a plurality thereof.

Advantages, features and applications of the present invention can be derived from the following embodiments with reference to the drawings.

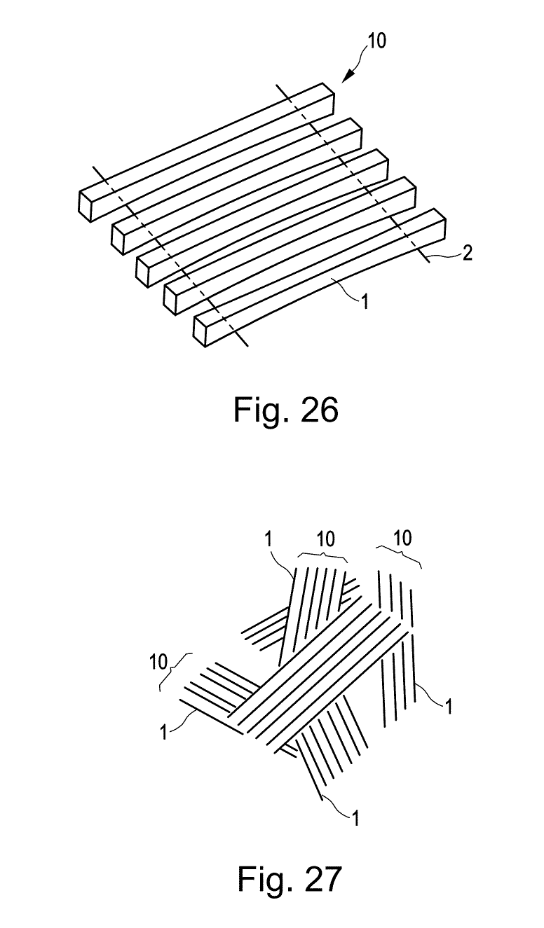

FIG. 26 shows a wooden element 10 according to the invention which has stick-like wooden elements 1 which are interconnected by means of a carrier material 2, wherein the stick-like wooden elements are spaced apart by a cavity. The production of these wooden elements can be carried out by stacking veneers to form a wooden block from which wooden sticks are cut transversely to the veneer surface and also approximately parallel to the wood fibre orientation, if necessary as an endless sheet. Alternatively, the rotary peeling of veneers is also possible, wherein a roller fitted with knives rotates on the peeling block and in the process makes cuts parallel to the peeling-block longitudinal axis at the distance of the desired width of the wooden stick so that wooden sticks are produced during the rotary peeling. The length of these sticks is determined both during the cutting off and during the rotary peeling by means of known co-rotating scoring knifes. The cohesion of this stick sheet is brought about by means of “endless binding material”, applied during the cut, such as fastening threads in a grid-like arrangement, a non-woven fabric, a foil, a woven fabric or a fusible plastic or hot-melt adhesive in order to hold together the individual wooden strips of the veneer sheet and consequently also the respectively cut-off veneer sheets. Such binding material exists as threads 2 in FIG. 26, for example. Directly before applying the preferably endless binding material, the cut-off sticks are spaced apart by means of a corresponding transporting mechanism. It is also possible, however, to undertake the spacing apart of the sticks after applying the binding material by the binding material being stretched with the sticks applied. The thereby resulting, preferably endlessly available band comprising spaced apart, short wooden sticks can now pass through a chopping mechanism in which it can be cut to a desired stick width, if this is desired.

According to a further embodiment, it is possible to produce the wooden sticks initially as a loose bulk without the use of a binding material, as is known in the production of matches. After the subsequent drying and gluing, these sticks, by means of a spreading and straightening mechanism, in an angular range of between 0° and 90° to each other, are formed into a mat and then adhesively bonded to each other in the process. This endless mat, in which the cohesion of the sticks is created by means of adhesive bonding at the intersection points, is then subsequently split into particle size by means of a cutting tool, wherein wooden elements 20 according to the invention are obtained. Such a wooden element 20 having intersecting stick-like wooden elements 1, which are interconnected at the intersection point by means of an adhesive, is shown in FIG. 29. It is also possible, by means of a technology known from the production of matches, to form from a loose bulk of wooden sticks a regular lattice comprising uniformly spaced apart wooden sticks and to fix these with the aforementioned binding material. Similarly, at least two regular lattices can be adhesively bonded together if the stick orientations of the lattices differ from each other by at least 10°.

FIG. 27 shows a detail of a core layer in which wooden elements 10 according to the invention, containing stick-like wooden elements 1 of FIG. 26, are arranged in an irregularly distributed manner. This core layer can be brought about by adhesive bonding of these wooden elements which are provided in advance with an adhesive and brought into contact with each other with a measured pressing force without the spaces between the individual wooden sticks being made smaller.

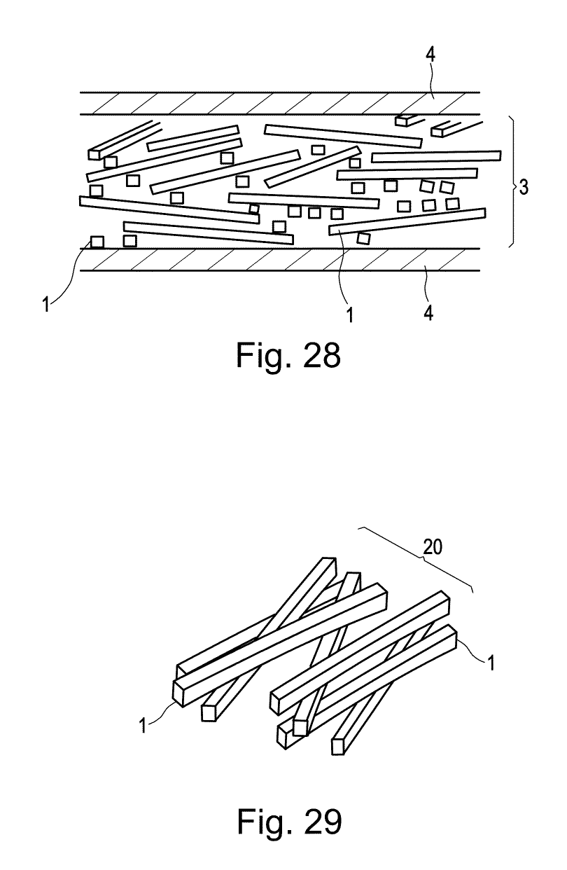

FIG. 28 shows a multi-layered composite, preferably in the form of a lightweight building board, having a cover layer 4 and a core layer 3. The lightweight building board is created by adhesive bonding of the core layer to highly stable cover layers 4, wherein the adhesive bonding can be combined with the forming of the core. Compared with the board which is disclosed in DE 1 924 619, the multi-layered composite according to the invention has the advantage that the wooden elements 10 according to the invention have an inherently very homogeneous structure and the stick-like wooden elements 1 remain essentially parallel to the cover layer 4 in the irregular distribution. Consequently, a homogeneous, open structure is created.

FIG. 29 shows a wooden element 20 according to the invention which has stick-like wooden elements 1 which intersect and are adhesively bonded together at the intersection point by means of an adhesive.

### LIST OF DESIGNATIONS FOR FIGS. 26-29

1 Stick-like wooden element
2 Carrier material
3 Core layer
4 Cover layer
20 Wooden element

Fourth Aspect of the Invention

According to a fourth aspect, the invention furthermore relates to the use of the multi-layered composite/multi-layered composites according to the invention and also to the use of the core layer according to the invention or the core layers according to the invention.

The multi-layered composite according to the invention, or the core layer according to the invention, can preferably be used in applications which call for high mechanical stress with relatively low weight. In one embodiment, the multi-layered composite or the core layer is used in furniture manufacture, for shelves, for packaging for transportation purposes, in interior work, in doors and gates, and also in vehicle construction and shipbuilding. To this end, the multi-layered composite or the core layer can be worked by means of cutting, sawing, filing and/or drilling according to known methods.

The core layer according to the invention and a multi-layered composite which has the core layer according to the invention, for example a lightweight building board, have a high resistance to compression and stress. With regard to this, the core layer and the multi-layered composite which is produced therefrom are superior to the corresponding core layers or multi-layered composites which are produced from industrial waste, chips and fibreboards. In addition, dimensional changes in the core layer or in the multi-layered composite influenced by moisture, especially dimensional changes in the direction of the thickness of the core layer or of the multi-layered composite, may be negligible on account of the negligible dimensional changes of the wooden element in fibre orientation. This is a further advantage compared with other known core layers and multi-layered composites which are produced therefrom, such as are produced, for example, from flat particles or from layers which are produced with parallel fibres, for example like plywood or fibreboards.

Common to the core layers or to the multi-layered composites according to the invention having the core layers according to the invention is that the core layers have an open structure which therefore enables low densities. The multi-layered composites according to the invention preferably have a density which is less than 500 kg/m³ or of less than 400 kg/m³. Especially preferred multi-layered composites have a density of between 80 and 350 kg/m3 or between 80 and 300 kg/m³ or between 80 and 250 kg/m³. At the same time, the core layers, however, are homogeneously constructed on account of the relatively small cavities which are located therein. This increases the stability of fastening means, such as nails or screws or furniture connectors, which are introduced therein so that said nails or screws are stably fixed in the multi-layered composite. In this way, a stable attachment on a support, preferably a wall, is also ensured.

A further advantage of the core layers according to the invention is that they are sufficiently homogeneous so that relatively thin coating materials, such as veneers, can also be supported with sufficiently high stability.

Also, it is possible in one embodiment to combine the core layers according to the invention according to the first aspect, to the second aspect and to the third aspect with each other. The combination can be effected by stacking core layers one on top of the other as well as by stringing the core layers together. Such combined core layers can be provided on one side, but preferably on both sides, with cover layers, wherein corresponding multi-layered composites can be produced.

In one embodiment, it is possible to combine a core layer according to the first aspect with a core layer according to the second aspect.

In a further embodiment, it is possible to combine a core layer according to the first aspect with a core layer according to the third aspect.

In one embodiment, it is possible to combine a core layer according to the first aspect with a core layer according to the second aspect and with a core layer according to the third aspect.

In a further embodiment, it is possible to combine a core layer according to the second aspect with a core layer according to the third aspect.

It is furthermore possible to also combine the core layers according to the invention with core layers as are known from the prior art.

What is claimed is:

1. A core layer comprising:
a first layer having first stick-like elements with a top and bottom surface;
a second layer having second stick-like elements with a top and bottom surface;
wherein the first stick-like elements of the first layer are spaced apart and separated from one another by a cavity;
wherein the second stick-like elements of the second layer are spaced apart and separated from one another by a cavity;
wherein the top surface of the first layer and the bottom surface of the second layer are overlaid such that the first stick-like elements of the first layer are not parallel to the second stick-like elements of the second layer; and
wherein the first layer and the second layer are fixedly interconnected.

2. The core layer according to claim 1, wherein the first stick-like elements and the second stick-like elements comprise wood.

3. The core layer according to claim 2, wherein the first layer and the second layer are overlaid so as to form a plane surface.

4. The core layer according to claim 1, wherein: (a) the first stick-like elements of the first layer are orientated parallel to each other; (b) the second stick-like elements of the second layer are orientated parallel to each other; or (c) the first stick-like elements of the first layer are orientated parallel to each other, and the second stick-like elements of the second layer are orientated parallel to each other.

5. The core layer according to claim 1, wherein the first and second layers are overlaid such that the first stick-like elements of the first layer are at an angle of 90° to the second stick-like elements of the second layer.

6. The core layer according to claim 1, further comprising a third layer having third stick-like elements with a top and bottom surface, wherein the third layer is overlaid the top of the second layer or the bottom of the first layer such that the third stick-like elements overlap with one of: (a) the cavities formed by the first stick-like elements of the first layer; or (b) the cavities formed by the second stick-like elements of the second layer; and wherein the bottom surface of the third layer is fixedly connected to one of: (a) the bottom surface of the first layer; or (b) the top surface of the second layer.

7. The core layer according to claim 6, wherein the first layer is fixedly connected to the second layer by at least one of:
(a) an adhesive; or
(b) a fourth layer of a material selected from at least one of: veneer, wooden board, chipboard, fibreboard, plywood board, plastic sheet, plasterboard, sheet metal plate, or fibre cement board; and
wherein said fourth layer is arranged between at least one of:
(a) the first layer and the second layer;
(b) the first layer and the third layer; or
(c) the second layer and the third layer.

8. The core layer according to claim 1, further comprising at least two first layers and at least two second layers, wherein the first layers and the second layers are arranged in an alternating manner.

9. The core layer according to claim 6, wherein the core layer consists of the first layer, the second layer, and the third layer.

10. A method for producing a core layer, the method comprising:
(i) arranging first stick-like elements having a top and bottom surface such that the first stick-like elements are spaced apart and separated from each other by a cavity, and thereby form a first layer;
(ii) arranging second stick-like elements having a top and bottom surface such that the second stick-like elements are spaced apart and separated from each other by a cavity, and thereby form a second layer; and
(iii) overlaying and fixedly connecting the top surface of the first layer to the bottom surface of the second layer such that the first stick-like elements of the first layer are not parallel to the second stick-like elements of the second layer.

11. The method according to claim 10, further comprising cutting the core layer in two parallel cutting planes, wherein the two parallel cutting planes extend obliquely to a plane surface formed by the first layer and the second layer.

12. The method according to claim 10, further comprising pressure deforming the core layer such that the first layer and the second layer do not form a plane surface.

13. The method according to claim 11, further comprising pressure deforming the core layer such that the first layer and the second layer do not form a plane surface.

14. A multi-layered composite comprising:
at least one cover layer having a top and bottom surface; and
at least one core layer having a top and bottom surface;
wherein the cover layer is arranged so that the bottom of the cover layer at least partially covers the top surface, bottom surface, or both of the core layer and is fixedly connected to the core layer;
wherein the core layer comprises:
a first layer having first stick-like elements with a top and bottom surface;
a second layer having second stick-like elements with a top and bottom surface;
wherein the first stick-like elements of the first layer are spaced apart and separated from one another by a cavity;
wherein the second stick-like elements of the second layer are spaced apart and separated from one another by a cavity;
wherein the top surface of the first layer and the bottom surface of the second layer are overlaid such that the first stick-like elements of the first layer are not parallel to the second stick-like elements of the second layer; and
wherein the first layer and the second layer are fixedly interconnected.

15. The multi-layered composite according to claim 14, wherein the cover layer comprises wood.

16. The multi-layered composite according to claim 14, wherein the cover layer is selected from at least one of: veneer, wooden board, chipboard, fibreboard, plywood board, plastic sheet, plasterboard, sheet metal plate, fibre cement board, or combinations thereof.

17. The multi-layered composite according to claim 14, further comprising at least one of: means for fastening the core layer to the cover layer; means for stiffening the multi-layered composite; means for insulating the multi-layered composite; means for fastening the multi-layered composite on a support; furniture connectors; or fittings.

18. The multi-layered composite according to claim 14, wherein the core layer further comprises a third layer having third stick-like elements with a top and bottom surface, wherein the third layer is overlaid the top surface of the second layer or the bottom surface of the first layer such that the third stick-like elements overlap with one of: (a) the cavities formed by the first stick-like elements of the first layer; or (b) the cavities formed by the second stick-like elements of the second layer; and wherein the bottom surface of the third layer is fixedly connected to one of: (a) the bottom surface of the first layer; or (b) the top surface of the second layer.

19. The multi-layered composite according to claim 14, wherein the core layer consists of:
a first layer having first stick-like elements with a top and bottom surface;
a second layer having second stick-like elements with a top and bottom surface;
a third layer having third stick-like elements with a top and bottom surface;
wherein the first stick-like elements of the first layer are spaced apart and separated from one another by a cavity;
wherein the second stick-like elements of the second layer are spaced apart and separated from one another by a cavity;
wherein the third stick-like elements of the third layer are spaced apart and separated from one another by a cavity;
wherein the top surface of the first layer and the bottom surface of the second layer are overlaid such that the first stick-like elements of the first layer are not parallel to the second stick-like elements of the second layer;
wherein the first layer and the second layer are fixedly interconnected;
wherein the third layer is overlaid the top surface of the second layer or the bottom surface of the first layer such that the third stick-like elements overlap with one of: (a) the cavities formed by the first stick-like elements of the first layer; or (b) the cavities formed by the second stick-like elements of the second layer; and wherein the bottom surface of the third layer is fixedly connected to one of: (a) the bottom surface of the first layer; or (b) the top surface of the second layer.

20. The multi-layered composite according to claim 14, wherein the multi-layered composite consists of a single core layer.
